(19) United States
(12) Patent Application Publication
(10) Pub. No.: US 2018/0301111 A1
(43) Pub. Date: Oct. 18, 2018

(54) ELECTRONIC DEVICE AND METHOD FOR DISPLAYING ELECTRONIC MAP IN ELECTRONIC DEVICE

(71) Applicant: Samsung Electronics Co., Ltd., Gyeonggi-do (KR)

(72) Inventors: Jeong-Min PARK, Gyeonggi-do (KR); Kwang-Sub SON, Gyeonggi-do (KR); Won-Suk CHOI, Seoul (KR)

(21) Appl. No.: 15/580,050

(22) PCT Filed: Jun. 7, 2016
(86) PCT No.: PCT/KR2016/005990

§ 371 Date: Dec. 6, 2017

(30) Foreign Application Priority Data
Jun. 8, 2015 (KR) 10-2015-0080894

(51) Int. Cl. G09G 5/00; G06F 17/30; G09G 5/32; G09G 5/26; G09B 29/00

(52) U.S. Cl. CPC G09G 5/005; G06F 17/30241; G09G 5/32; G09G 5/26; G09G 2354/00; G09G 2340/145; G09G 2360/122; G09G 2340/045; G09B 29/00

(57) ABSTRACT

Various embodiments of the present invention relate to an electronic device which may comprise: a storage unit for storing a map component configuring an electronic map; a control unit for making a control to re-configure, according to a configured condition, at least one selected map component among the map components stored in the storage unit, and generate the electronic map using the re-configured map component; and a display unit for displaying the generated electronic map on a screen. Further, various embodiments of the present invention may include other embodiments.

### TECHNICAL FIELD

Various embodiments of the present invention relate to electronic devices and methods for displaying a map on an electronic device.

### BACKGROUND ART

Generally, the electronic device means a device performing a particular function according to its equipped program, such as a home appliance, an electronic scheduler, a portable multimedia player, a mobile communication terminal, a tablet PC, a video/sound device, a desktop PC or laptop computer, a navigation for automobile, etc. For example, electronic devices may output stored information as voices or images. As electronic devices are highly integrated and high-speed, high-volume wireless communication becomes commonplace, mobile communication terminals are recently being equipped with various functions.

For example, an electronic device comes with the integrated functionality, including an entertainment function, such as playing video games, a multimedia function, such as replaying music/videos, a communication and security function for mobile banking, and a scheduling or e-wallet function.

Electronic maps may be displayed on the screen of various sizes of display means provided in various sizes of electronic devices. An electronic map displayed on an electronic device represents natural topography or buildings or other geographic features in the same or similar manner to actual ones.

An electrode may be displayed in various forms, e.g., two-dimension (2D), 2.5D, or 3D. Further, electronic maps may be classified in various types into, e.g., indoor maps, topographical maps, traffic maps, city maps, weather maps, or theme maps, depending on the type of objects to be displayed. The various maps listed above may be displayed on the screen of the electronic device according to uses. An electronic device may be displayed on, e.g., a wearable device, smartphone, tablet, laptop computer, desktop PC, table PC, smart TV, or an electronic board, depending on the size of the display means (e.g., a touchscreen).

### DETAILED DESCRIPTION OF THE INVENTION

### Technical Problem

An electronic map may display points of interest (POIs), as detailed information, as well as its unique geographic feature information. An electronic device may also display overlay information, e.g., traffic information, on existing map information.

However, displaying or listing too much information may render it difficult for the user to immediately search for her desired information. Further, dense information on the size-limited screen may get the user into difficulty in finding her desired location or information, causing inconvenience for a separate input.

For example, watch-type wearable devices which are put on the user's body, e.g., smartwatches, may have a relatively small screen size as compared with smartphones or tablets. Due to the size restriction, the size-limited screen may not contain lots of information. Further, displaying much information on the size-limited screen, such as of a wearable device may lower the recognition rate for the map.

In contrast to typical maps, electronic maps enable a quick and easier search for desired location information through various user experiences (UXs). By their nature, however, text information and picture information together should be displayed, and the context that the user recognizes may be varied depending on the deployment of pictures and texts. Since wearable devices or other small-screen electronic devices are proliferating, and more usability is driven for location information notification functions based on the user's location and location-based service (LBS), a need exits for a method for the user to quickly and precisely recognize her desired location through an electronic map.

According to various embodiments of the present invention, there may be provided an electronic device that may reconfigure map components of an electronic map to allow the user to easily and quickly recognize information through the electronic map without losing the informative nature unique to the map and a method for displaying an electronic map on an electronic device.

Further, according to various embodiments of the present invention, there may be provided an electronic device that may reconfigure map components of an electronic map to fit the context in which the user may easily recognize them, allowing the user to intuitively and easily recognize the electronic map and a method for displaying an electronic map on an electronic device.

### Technical Solution

To address the foregoing or other problems, according to an embodiment of the present invention, an electronic device may comprise a storage unit storing map components, a controller performing control to reconfigure at least one of the map components stored in the storage unit according to a preset condition and to generate an electronic map using the reconfigured map components, and a display unit displaying the generated electronic map on a screen.

Also, according to any one of various embodiments, a method for displaying an electronic map on an electronic device may comprise the operations of selecting at least one of map components constituting the electronic map, reconfiguring the at least one selected map component according to a preset condition, and generating the electronic map using the reconfigured map component.

### Advantageous Effects

By an electronic device and method for displaying an electronic map on an electronic device according to various embodiments, higher recognition may be achieved even for such electronic devices as watch-type wearable devices which have a limitation in screen size.

For example, a wearable device, e.g., a watch-type wearable device, is generally subject to limitations in screen size by its nature of being worn. The small screen of the watch-type wearable device has relatively less pixels and smaller physical size, and it thus calls for a minimum size in which the user may read text or objects.

Further, recognition outdoors or on the move requires clearer display. Thus, a limitation is imposed on information displayed on the map. An attempt to display lots of information may increase the density of information displayed and complicate the configuration of information, lowering visibility.

In an electronic device and method for displaying an electronic map on an electronic device according to various embodiments of the present invention, map components may be simplified and displayed in displaying the map on a small-screen electronic device which is frequently checkable outdoors or on the move.

For example, normal displays are rectangular, and conventional maps have been optimized for such display form. According to various embodiments of the present invention, an electronic map may appropriately be displayed with map components reconfigured according to whether the display is shaped as a circle, rectangle, or a curve. This may serve the user in a manner optimized for the display shape as escaping from the stereotype of conventional electronic maps.

For example, electronic maps are intended for locating the user's desired destination. Such purpose may be divided into various more detailed ones, e.g., heading for the destination, looking up a contact, viewing reviews, etc. By way of example, urbanized modern society drives more use of indoor maps or building maps as well as normal street maps.

By an electronic device and method for displaying an electronic map on an electronic device according to various embodiments of the present invention, an electronic map may be reconfigured into a map-based user interface (UI) that may raise user convenience while maintaining locations unique to map. According to various embodiments of the present invention, the user may be allowed to select an area of a geographical area-reconfigured frame, rather than narrow POIs on the map, easily choosing her desired destination. According to various embodiments of the present invention, a UI that is more legible while maintaining location information unique to map may be provided to various types of wearable devices that are difficult to control on the size-limited, small screen.

### BRIEF DESCRIPTION OF DRAWINGS

FIG. 1 is a view illustrating a network configuration according to an embodiment of the present invention;

FIG. 2 is a view illustrating an electronic map display screen according to an embodiment of the present invention;

FIG. 3 is a view illustrating an electronic map display screen according to an embodiment of the present invention;

FIG. 4 is a view illustrating communication between electronic devices according to an embodiment of the present invention;

FIG. 5 is a view illustrating an example of a configuration of an electronic device according to an embodiment of the present invention;

FIG. 6a is a view illustrating a tile section of an electronic map according to various embodiments of the present invention;

FIG. 6b is a view illustrating tile sections of an electronic map according to various embodiments of the present invention;

FIG. 6c is a view illustrating tile sections of an electronic map according to various embodiments of the present invention;

FIG. 7 is a view illustrating layers of an electronic map according to various embodiments of the present invention;

FIG. 8 is a view illustrating a layered structure of an electronic map according to an embodiment of the present invention;

FIG. 9 is a view illustrating examples of simplifying an electronic map according to various embodiments of the present invention;

FIG. 10 is a flowchart illustrating a procedure for generating an electronic map according to various embodiments of the present invention;

FIG. 11 is a flowchart illustrating a procedure for reconfiguring map components according to various embodiments of the present invention;

FIG. 12 is a flowchart illustrating a procedure for displaying an electronic map with point-of-interest (POI) thumbnail frames according to various embodiments of the present invention;

FIG. 13a is a view illustrating map data according to various embodiments of the present invention;

FIG. 13b is a view illustrating thumbnail frames according to various embodiments of the present invention;

FIG. 13c is a view illustrating POI information per frame according to various embodiments of the present invention;

FIG. 13d is a view illustrating thumbnail frames showing POI information according to various embodiments of the present invention;

FIG. 14 is a flowchart illustrating a procedure for displaying an electronic map with distance-based frames according to various embodiments of the present invention;

FIG. 15 is a view illustrating an electronic map before distorted according to various embodiments of the present invention;

FIG. 16 is a view illustrating a distorted electronic map according to various embodiments of the present invention;

FIG. 17 is a view illustrating the concept of a distorted electronic map according to various embodiments of the present invention;

FIG. 18 is a flowchart illustrating a procedure for displaying an electronic map with level frames according to various embodiments of the present invention;

FIG. 19 is a view illustrating an electronic map with level frames according to various embodiments of the present invention;

FIG. 20 is a view illustrating an example of switching level frames according to various embodiments of the present invention;

FIG. 21 is a flowchart illustrating a procedure for displaying an electronic map with interactive map frames according to various embodiments of the present invention;

FIG. 22 is a view illustrating an example of displaying an electronic map with interactive map frames according to various embodiments of the present invention;

FIG. 23 is a view illustrating an example of controlling interactive map frames according to various embodiments of the present invention;

FIG. 24 is a view illustrating an example of controlling interactive map frames according to various embodiments of the present invention;

FIG. 25 is a view illustrating an example of operating interactive map frames according to various embodiments of the present invention;

FIG. 26 is a flowchart illustrating a procedure for displaying an electronic map with pattern frames according to various embodiments of the present invention;

FIG. 27 is a view illustrating a procedure for displaying an electronic map with pattern frames according to various embodiments of the present invention;

FIG. 28 is a view illustrating a procedure for displaying an electronic map with pattern frames according to various embodiments of the present invention;

FIG. 29 is a flowchart illustrating a procedure for displaying an electronic map with simplified map vector data according to various embodiments of the present invention;

FIG. 30 is a view illustrating an example of displaying an electronic map before subjected to a simplification process according to various embodiments of the present invention;

FIG. 31a is a view illustrating an example of displaying an electronic map that has undergone a simplification process according to various embodiments of the present invention;

FIG. 31b is a view illustrating an example of displaying an electronic map that has undergone a simplification process according to various embodiments of the present invention;

FIG. 31c is a view illustrating an example of displaying an electronic map that has undergone a simplification process according to various embodiments of the present invention;

FIG. 32 is a view illustrating an example of transmitting simplified map vector data according to various embodiments of the present invention;

FIG. 33 is a block diagram illustrating a detailed structure of an electronic device according to an embodiment of the present invention; and

FIG. 34 is a block diagram illustrating a program module according to an embodiment of the present invention.

### MODE FOR CARRYING OUT THE INVENTION

Hereinafter, embodiments of the present invention are described with reference to the accompanying drawings. However, it should be appreciated that the present invention is not limited to the embodiments, and all changes and/or equivalents or replacements thereto also belong to the scope of the present invention. The same or similar reference denotations may be used to refer to the same or similar elements throughout the specification and the drawings.

As used herein, the terms “have,” “may have,” “include,” or “may include” a feature (e.g., a number, function, operation, or a component such as a part) indicate the existence of the feature and do not exclude the existence of other features.

As used herein, the terms “A or B,” “at least one of A and/or B,” or “one or more of A and/or B” may include all possible combinations of A and B. For example, “A or B,” “at least one of A and B,” “at least one of A or B” may indicate all of (1) including at least one A, (2) including at least one B, or (3) including at least one A and at least one B.

As used herein, the terms “first” and “second” may modify various components regardless of importance and do not limit the components. These terms are only used to distinguish one component from another. For example, a first user device and a second user device may indicate different user devices from each other regardless of the order or importance of the devices. For example, a first component may be denoted a second component, and vice versa without departing from the scope of the present invention.

It will be understood that when an element (e.g., a first element) is referred to as being (operatively or communicatively) “coupled with/to,” or “connected with/to” another element (e.g., a second element), it can be coupled or connected with/to the other element directly or via a third element. In contrast, it will be understood that when an element (e.g., a first element) is referred to as being “directly coupled with/to” or “directly connected with/to” another element (e.g., a second element), no other element (e.g., a third element) intervenes between the element and the other element.

As used herein, the terms “configured (or set) to” may be interchangeably used with the terms “suitable for,” “having the capacity to,” “designed to,” “adapted to,” “made to,” or “capable of” depending on circumstances. The term “configured (or set) to” does not essentially mean “specifically designed in hardware to.” Rather, the term “configured to” may mean that a device can perform an operation together with another device or parts. For example, the term “processor configured (or set) to perform A, B, and C” may mean a generic-purpose processor (e.g., a CPU or application processor) that may perform the operations by executing one or more software programs stored in a memory device or a dedicated processor (e.g., an embedded processor) for performing the operations.

The terms as used herein are provided merely to describe some embodiments thereof, but not to limit the scope of other embodiments of the present invention. It is to be understood that the singular forms “a,” “an,” and “the” include plural references unless the context clearly dictates otherwise. All terms including technical and scientific terms used herein have the same meaning as commonly understood by one of ordinary skill in the art to which the embodiments of the present invention belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein. In some cases, the terms defined herein may be interpreted to exclude embodiments of the present invention.

For example, examples of the electronic device according to embodiments of the present invention may include at least one of a smailphone, a tablet personal computer (PC), a mobile phone, a video phone, an e-book reader, a desktop PC, a laptop computer, a netbook computer, a workstation, a PDA (personal digital assistant), a portable multimedia player (PMP), an MP3 player, a mobile medical device, a camera, or a wearable device (e.g., smart glasses, a head-mounted device (HMD), electronic clothes, an electronic bracelet, an electronic necklace, an electronic appcessory, an electronic tattoo, a smart mirror, or a smart watch).

According to an embodiment of the present invention, the electronic device may be a smart home appliance. For example, examples of the smart home appliance may include at least one of a television, a digital video disk (DVD) player, an audio player, a refrigerator, an air conditioner, a cleaner, an oven, a microwave oven, a washer, a drier, an air cleaner, a set-top box, a home automation control panel, a security control panel, a TV box (e.g., Samsung HomeSync™, Apple TV™, or Google TV™) , a gaming console (Xbox™, PlayStation™), an electronic dictionary, an electronic key, a camcorder, or an electronic picture frame.

According to an embodiment of the present invention, examples of the electronic device may include at least one of various medical devices (e.g., diverse portable medical measuring devices (a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, an sailing electronic device (e.g., a sailing navigation device or a gyro compass), avionics, security devices, vehicular head units, industrial or home robots, automatic teller's machines (ATMs), point of sales (POS) devices, or Internet of Things devices (e.g., a bulb, various sensors, an electric or gas meter, a sprinkler, a fire alarm, a thermostat, a street light, a toaster, fitness equipment, a hot water tank, a heater, or a boiler).

According to various embodiments of the disclosure, examples of the electronic device may at least one of furniture, part of a building/structure, an electronic board, an electronic signature receiving device, a projector, or various measurement devices (e.g., devices for measuring water, electricity, gas, or electromagnetic waves). According to an embodiment of the present invention, the electronic device may be one or a combination of the above-listed devices. According to an embodiment of the present invention, the electronic device may be a flexible electronic device. According to an embodiment of the present invention, the electronic device is not limited to the above-listed devices, and may include new electronic devices depending on the development of technology.

In various embodiments of the present invention described below, “electronic map” means a map displayed on the screen of an electronic device, and the electronic map may include various pieces of information displayable on a map as well as geographical information.

In various embodiments of the present invention described below, “map components” may be components that constitute at least part of an electronic map and may include text, a point of interest (POI), a road, and a land. Also, according to various embodiments of the present invention, the map component may include at least of information regarding the size of a predesignated area on an electronic map, information regarding a street included in a predesignated area on the electronic map, information regarding a building included in a predesignated area on the electronic map, information regarding a block included in a predesignated area on the electronic map, information regarding an administrative district included in a predesignated area on the electronic map, information regarding a landmark included in a predesignated area on the electronic map, and information regarding topology included in a predesignated area on the electronic map.

Hereinafter, electronic devices are described with reference to the accompanying drawings, according to various embodiments of the present invention. As used herein, the term “user” may denote a human or another device (e.g., an artificial intelligent electronic device) using the electronic device.

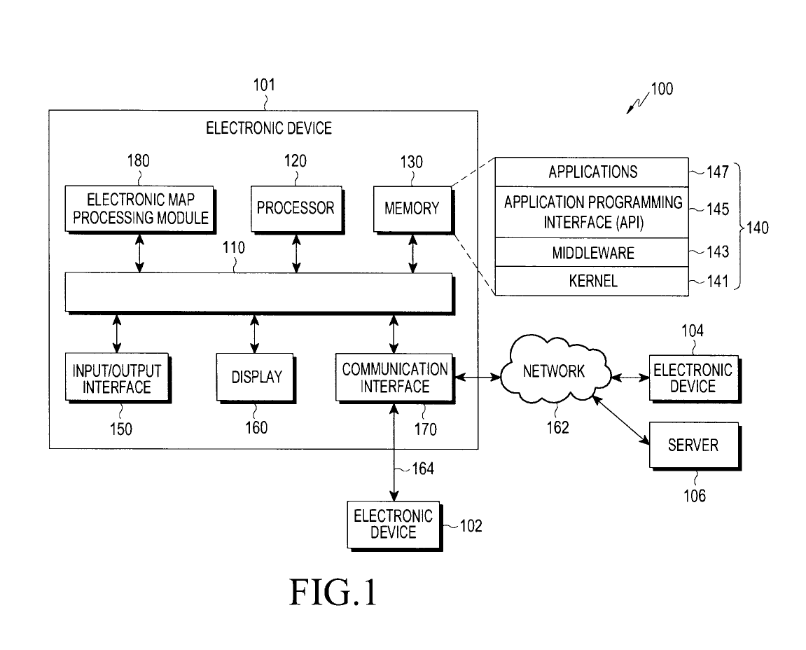

Referring to FIG. 1, according to an embodiment of the present invention, an electronic device 100 is included in a network environment 101. The electronic device 101 may include at least one of a bus 110, a processor 120, a memory 130, an input/output interface 150, a display 160, a communication interface 170, or an electronic map processing module 180. In some embodiments, the electronic device 101 may exclude at least one of the components or may add another component.

The bus 110 may include a circuit for connecting the components 110 to 180 with one another and transferring communications (e.g., control messages and/or data) between the components.

The processor 120 may include one or more of a central processing unit (CPU), an application processor (AP), or a communication processor (CP). The processor 120 may perform control on at least one of the other components of the electronic device 101, and/or perform an operation or data processing relating to communication.

The memory 130 may include a volatile and/or non-volatile memory. For example, the memory 130 may store commands or data related to at least one other component of the electronic device 101. According to an embodiment of the present invention, the memory 130 may store software and/or a program 140. The program 140 may include, e.g., a kernel 141, middleware 143, an application programming interface (API) 145, and/or an application program (or “application”) 147. At least a portion of the kernel 141, middleware 143, or API 145 may be denoted an operating system (OS).

For example, the kernel 141 may control or manage system resources (e.g., the bus 110, processor 120, or a memory 130) used to perform operations or functions implemented in other programs (e.g., the middleware 143, API 145, or application program 147). The kernel 141 may provide an interface that allows the middleware 143, the API 145, or the application 147 to access the individual components of the electronic device 101 to control or manage the system resources.

The middleware 143 may function as a relay to allow the API 145 or the application 147 to communicate data with the kernel 141, for example. A plurality of applications 147 may be provided. The middleware 143 may control work requests received from the applications 147, e.g., by allocation the priority of using the system resources of the electronic device 101 (e.g., the bus 110, the processor 120, or the memory 130) to at least one of the plurality of applications 134.

The API 145 is an interface allowing the application 147 to control functions provided from the kernel 141 or the middleware 143. For example, the API 133 may include at least one interface or function (e.g., a command) for filing control, window control, image processing or text control.

The input/output interface 150 may serve as an interface that may, e.g., transfer commands or data input from a user or other external devices to other component(s) of the electronic device 101. Further, the input/output interface 150 may output commands or data received from other component(s) of the electronic device 101 to the user or the other external device.

The display 160, as a means able to display an electronic map according to various embodiments of the present invention, may include, e.g., a liquid crystal display (LCD), a light emitting diode (LED) display, an organic light emitting diode (OLED) display, or a microelectromechanical systems (MEMS) display, or an electronic paper display. The display 160 may display, e.g., various contents (e.g., text, images, videos, icons, or symbols) to the user. The display 160 may include a touchscreen and may receive, e.g., a touch, gesture, proximity or hovering input using an electronic pen or a body portion of the user.

For example, the communication interface 170 may set up communication between the electronic device 101 and an external electronic device (e.g., a first electronic device 102, a second electronic device 104, or a server 106). For example, the communication interface 170 may be connected with the network 162 through wireless or wired communication to communicate with the external electronic device (e.g., the second external electronic device 104 or server 106). For example, the communication interface 170 may directly communicate with the external device (e.g., the first external electronic device 102) via wired or wireless communication. In the following embodiments, when the electronic device 101 is a smartphone, the first external electronic device 102 may be a wearable device. For example, according to an embodiment of the present invention, the smartphone and the wearable device may communicate with each other to communicate information related to the electronic map.

The wireless communication may use at least one of, e.g., long term evolution (LTE), long term evolution- advanced (LTE-A), code division multiple access (CDMA), wideband code division multiple access (WCDMA), universal mobile telecommunication system (UMTS), wireless broadband (WiBro), or global system for mobile communication (GSM), as a cellular communication protocol. The wired connection may include at least one of, e.g., universal serial bus (USB), high definition multimedia interface (HDMI), recommended standard (RS)-232, or plain old telephone service (POTS). The network 162 may include at least one of communication networks, e.g., a computer network (e.g., local area network (LAN) or wide area network (WAN)), Internet, or a telephone network.

The first and second external electronic devices 102 and 104 each may be a device of the same or a different type from the electronic device 101. According to an embodiment of the present invention, the server 106 may include a group of one or more servers. According to an embodiment of the present invention, all or some of operations executed on the electronic device 101 may be executed on another or multiple other electronic devices (e.g., the electronic devices 102 and 104 or server 106). According to an embodiment of the present invention, when the electronic device 101 should perform some function or service automatically or at a request, the electronic device 101, instead of executing the function or service on its own or additionally, may request another device (e.g., electronic devices 102 and 104 or server 106) to perform at least some functions associated therewith. The other electronic device (e.g., electronic devices 102 and 104 or server 106) may execute the requested functions or additional functions and transfer a result of the execution to the electronic device 101. The electronic device 101 may provide a requested function or service by processing the received result as it is or additionally. To that end, a cloud computing, distributed computing, or client-server computing technique may be used, for example.

Although FIG. 1 shows that the electronic device 101 includes the communication interface 170 to communicate with the external electronic device 104 or 106 via the network 162, the electronic device 101 may be independently operated without a separate communication function, according to an embodiment of the present invention.

The server 106 may support to drive the electronic device 101 by performing at least one of operations (or functions) implemented on the electronic device 101. For example, the server 106 may include an electronic map processing server module (not shown) that may support the electronic map processing module 180 implemented in the electronic device 101. For example, the electronic map processing server module may include at least one of the components of the electronic map processing module 180 and perform (or instead perform) at least one of the operations (or functions) conducted by the electronic map processing module 180. According to various embodiments of the present invention, the server 106 may be an electronic map providing server capable of providing various electronic map-related functions to the electronic device 101.

The electronic map processing module 180 may process at least part of information obtained from other elements (e.g., the processor 120, the memory 130, the input/output interface 150, or the communication interface 170) and may provide the same to the user in various manners.

For example, according to various embodiments of the present invention, the electronic map processing module 180 may perform the functions of extracting, from the memory 130, at least one electronic map component constituting an electronic map, reconfiguring the extracted electronic map component according to a set condition to generate an electronic map, or outputting the generated electronic map through the display 160 or transmitting the generated electronic map through the communication interface 170 to other electronic devices 102 and 104. Additional information about the electronic map processing module 180 is provided through FIG. 5 described below.

Although in FIG. 1 the electronic map processing module 180 is shown to be a module separate from the processor 120, at least a portion of the electronic map processing module 180 may be included or implemented in the processor 120 or at least one other module, or the overall function of the electronic map processing module 180 may be included or implemented in the processor 120 shown or another processor.

The electronic map requires space perception ability and object recognition ability as compared with text or picture information that may directly be recognized, and the electronic map may also require prior knowledge to some degree. In contrast to typical maps, electronic maps enable a quick and easier search for desired location information through various user experiences (UXs). By their nature, however, text information and picture information together should be displayed, and the context that the user recognizes may be varied depending on the deployment of pictures and texts.

Since wearable devices or other small-screen devices are proliferating, and more usability is driven for location information notification functions based on the user's location and location-based service (LBS), a need exits for a method for the user to quickly and precisely recognize her desired location. For example, there is a need for a display method allowing the user quick and easy recognition without losing the unique informative capability of map even on small screens.

In the electronic map according to various embodiments of the present invention described below, at least one map component constituting the electronic map may be reconfigured to be suited for the context where the user's recognition is easy, allowing the user to intuitively and easily recognize the electronic map. The electronic map according to various embodiments of the present invention simultaneously enables effective delivery of information without losing the unique informative capability of map even on small-size displays, e.g., wearable devices.

The electronic map reconfigured according to various embodiments of the present invention described below may be generated by simplifying recognition. For example, the display may be simplified by contrasting colors of information displayed, adjusting the size or direction of text, and reconfiguring a curved street into a linear road. According to various embodiments of the present invention, POIs displayed on the map may be filtered based on preset priority, thereby enabling providing only necessary POI information and allowing the user to intuitively recognize the map without relying on map reading.

The electronic map reconfigured according to various embodiments of the present invention described below may enable display of optimized information even on small screens, as working powerful for glance view. For example, the electronic map according to various embodiments of the present invention may be applied to wearable devices, enabling the same to be checked even on jogging.

Further, the electronic map reconfigured according to various embodiments of the present invention may enable selection and display of a meaningful context, resultantly providing a map-based intuitive UX. Thus, the electronic map may be displayed in an intuitive and easy-to-recognize manner as are advertisements, and when applied to indoor maps, enables effective display of map information.

Further, the electronic map reconfigured according to various embodiments of the present invention described below may minimize data size (e.g., data volume) and reduce map tile information and map size. Further, it reduces the amount of data to be read in to generate the electronic map, shortening information transmission time or rendering time.

According to various embodiments of the present invention described below, electronic map information may be reconfigured fitting the properties of the electronic device and displayed on the screen.

The electronic map may be represented on a majority of electronic devices with a displaying means. As set forth above, the electronic map may be used in portable electronic devices that a human being may carry on the move, such as wearable devices, smartphones, tablets, or laptop computers. The electronic map may be displayed on the center fascia of automobiles, displays for bus, subway, or other public transportation passengers, the seat display of airplanes, or other mobile devices. The electronic map may also be displayed on stationary devices, e.g., desktop PCs, smart TVs, refrigerator wall displays, interphones, table PCs, or e-boards.

According to various embodiments of the present invention, the electronic map may differently be displayed depending on whether the user moves. For example, for mobile electronic devices, a UX may be included that displays the user's current location through the GPS, Wi-Fi, BLE, or other positioning means. It may include a mode in which the user's current location is continuously tracked as does navigation and a mode that enables the user's control through arbitrary manipulation.

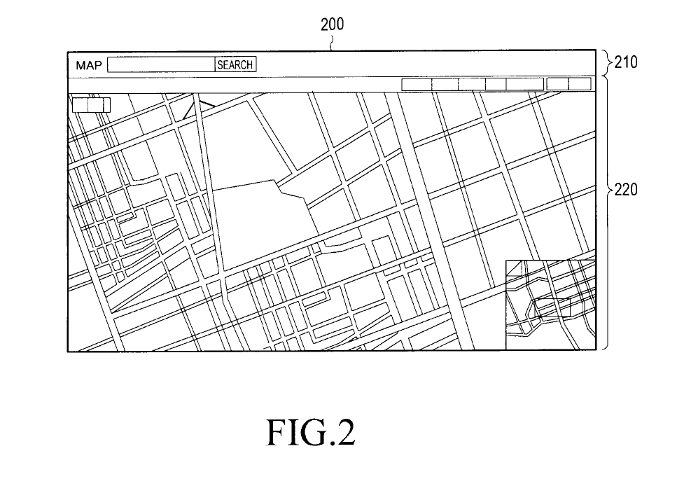

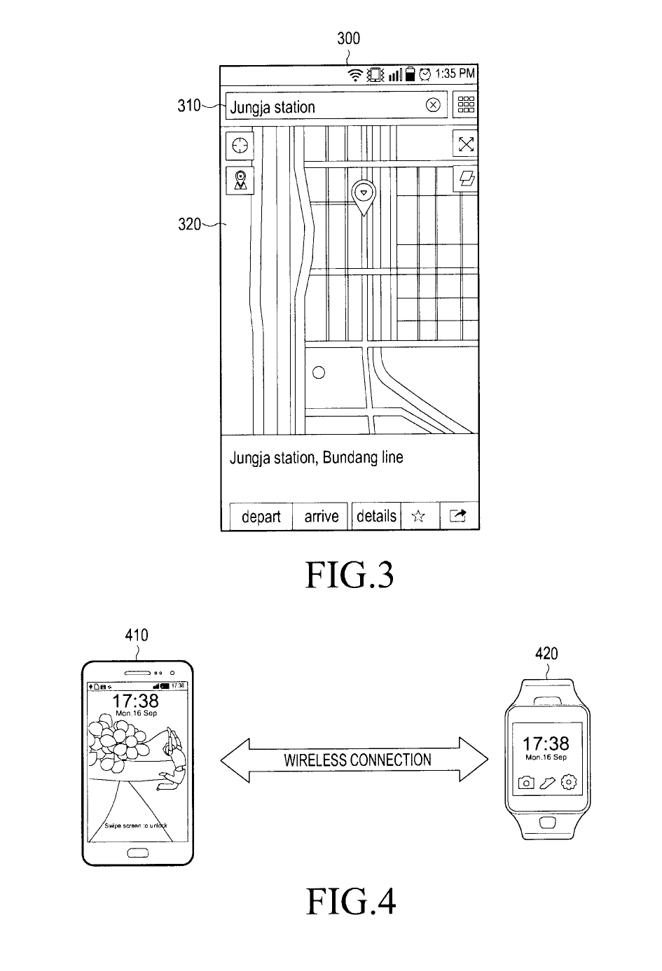

FIGS. 2 and 3 are views illustrating an electronic map display screen according to an embodiment of the present invention. Referring to FIGS. 2 and 3, an electronic map may differently be displayed depending on the size of the display device.

For example, for a larger screen, such as that of a TV, as shown in FIG. 2, a basic zoom level may be set as a city level, and for a relatively small screen, such as that of a smartphone, as shown in FIG. 3, the basic zoom level may be set as a street level. For a relatively large screen as shown in FIG. 2, the overall screen 200 may be split and used as, e.g., a user input area 210, a user menu area, and a wide map display area 220. For a relatively small screen 300 as shown in FIG. 3, however, the menu 310 may be displayed in a minimized size or overlaid on the map to display the map area 320 as broad as possible. Further, in the electronic device (e.g., a watch-type wearable device) having a smaller display area than the screen 300 in FIG. 3, according to various embodiments of the present invention, the map components constituting the electronic map may be simplified or reconfigured, enhancing legibility.

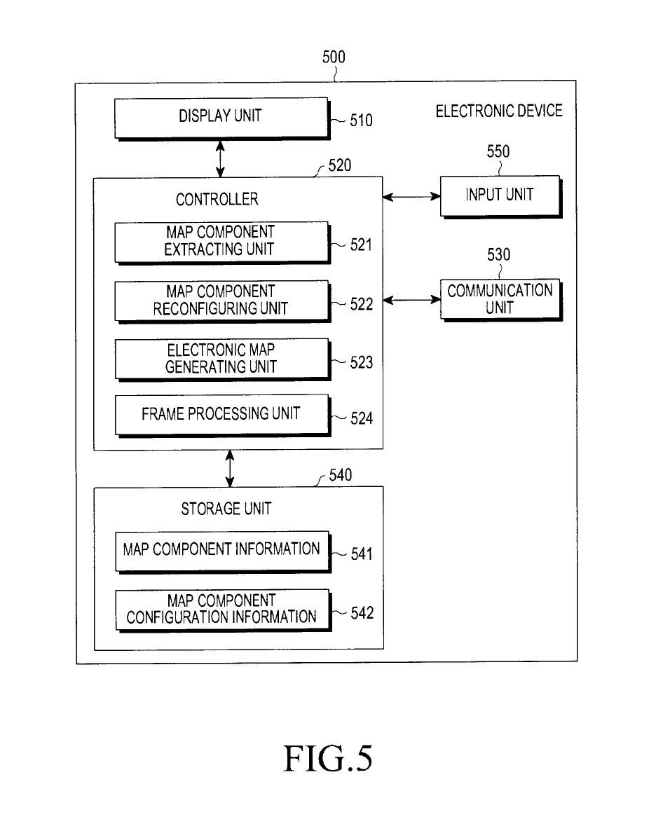

FIG. 4 is a view illustrating communication between electronic devices according to an embodiment of the present invention. Referring to FIG. 4, an example of the first electronic device 101 shown in FIG. 1 may be a smai (phone 410, and an example of the second electronic device 102 or 104 may be a watch-type wearable device 420. However, embodiments of the present invention are not limited to the devices.

As set forth above, the smartphone 410 and the watch-type wearable device 420 may communicate with each other via a wired/wireless communication means, but embodiments of the present invention are not limited thereto.

According to various embodiments of the present invention, the smartphone 410 or the watch-type wearable device 420 may display a reconfigured electronic map and exchange information related to the displayed electronic map. Further, one device may send information to control the electronic map to the other device, enabling control between the devices. Relevant detailed embodiments are described below. Further, either one (e.g., the smartphone 410) may send data obtained by reconfiguring the map components to the other device (e.g., the watch-type wearable device 420), and the device receiving the reconfigured data may display a simplified and more legible electronic map using the received information.

Meanwhile, for ease of description, in the following embodiments of the present invention, an example of the first electronic device 101 or the second electronic device 102 or 104 is described as a smartphone 410 or a watch-type wearable device 420 as shown in FIG. 4, but embodiments of the present invention are not limited to the devices.

FIG. 5 is a view illustrating an example of a configuration of an electronic device according to an embodiment of the present invention. According to various embodiments of the present invention, the electronic device 500 may include at least one of a display unit 510, a controller 520, a communication unit 530, a storage unit 540, and an input unit 550. According to various embodiments of the present invention, the controller 520 may include at least one of a map component extracting unit 521, a map component reconfiguring unit 522, an electronic map generating unit 523, and a frame processing unit 524.

All or some of the functions of each component of the electronic device 500 of FIG. 5 may be included in at least one component of FIG. 1. For example, at least part of the controller 520 may be included in the electronic map processing module 180 or processor 120 of FIG. 1. At least a portion of the storage unit 540 may be included in the memory 130 of FIG. 1, and at least a portion of the displaying unit 510 may be included in the display 160 of FIG. 1. At least a portion of the communication unit 530 may be included in the communication interface 170 of FIG. 1.

Map component information 541 or map component configuration information 542 may be included in the storage unit 540. The information stored in the storage unit 540 may be provided from an electronic device (e.g., a server or another electronic device) outside the electronic device 500. The storage unit 540 may further include various pieces of information (e.g., geographic information system (GIS)-related information) related to an electronic map.

The GIS means an integrated body of geographical material, human resources, and computer hardware and software designed to be able to effectively gather, store, update, adjust, analyze, and represent various forms of information that may be referenced in a geographical and spatial manner The electronic map-related information stored in the storage unit 540 may include one data model to represent spatial information in the GIS.

Example methods for representing the spatial information include a raster data scheme and a vector data scheme. The raster data scheme may represent a space using a grid or grid cells. In contrast, the vector data scheme may represent a dot, line, or area in a space using dots and x and y coordinates.

In the raster data scheme, an electronic map may be represented as an enlargeable or shrinkable image. For example, a representative example of the raster data scheme may be a map displayed with, e.g., aerial/satellite photographs. For example, a map-like image, such as in Joint Photographic Experts Group (JPEG) format, may be displayed in the raster data scheme.

The vector data scheme may be constituted of geological elements, such as points, lines, or polygons. A point may represent a POI, and a line may represent a river, road, or rail. A polygon may represent a part border, building, city border, or land.

Now described is an example of a data format for electronic map data as per the raster data scheme that may be stored in the storage unit 540.

<Raster Data Format>

A. ADRG—National Geospatial-Intelligence Agency (NGA)'s ARC Digitized Raster Graphics[2]

B. CADRG—National Geospatial-Intelligence Agency (NGA)'s Compressed ARC Digitised Raster Graphics (nominal compression of 55,1 over ADRG)

C. CIB—National Geospatial-Intelligence Agency (NGA)'s Controlled Image Base (type of Raster Product Format)

D. Digital raster graphic (DRG)—digital scan of a paper USGS topographic map

E. ECRG—National Geospatial-Intelligence Agency (NGA)'s Enhanced Compressed ARC Raster Graphics (Better resolution than CADRG and no color loss)

F. ECW—Enhanced Compressed Wavelet (from ERDAS). A compressed wavelet format, often lossy.

G. Esri grid—proprietary binary and metadataless ASCII raster formats used by Esri

H. GeoTIFF—TIFF variant enriched with GIS relevant metadata

I. IMG—ERDAS IMAGINE image file format

J. JPEG2000—Open-source raster format. A compressed format, allows both lossy and lossless compression.

K. MrSID—Multi-Resolution Seamless Image Database (by Lizardtech). A compressed wavelet format, allows both lossy and lossless compression.

L. netCDF-CF—netCDF file format with CF medata conventions for earth science data. Binary storage in open format with optional compression. Allows for direct web-access of subsets/aggregations of maps through OPeNDAP protocol.

M. RPF′—Raster Product Format specified in MIL-STD-2411[3]

Now described is an example of a data format for electronic map data as per the vector data scheme that may be stored in the storage unit 540.

<Vector Data Format>

A. AutoCAD DXF—contour elevation plots in AutoCAD DXF format (by Autodesk)

B. Cartesian coordinate system (XYZ)—simple point cloud

C. Digital Line Graph (DLG)—a USGS format for vector data

D. Geography Markup Language (GML)—XML based open standard (by OpenGIS) for GIS data exchange

E. GeoJSON—a lightweight format based on JSON, used by many open source GIS packages

F. GeoMedia—Intergraph's Microsoft Access based format for spatial vector storage

G. ISFC—Intergraph's MicroStation based CAD solution attaching vector elements to a relational Microsoft Access database

H. Keyhole Markup Language (KML)—XML based open standard (by OpenGIS) for GIS data exchange

I. Mapinfo TAB format—Mapinfo's vector data format using TAB, DAT, ID and MAP files

J. National Transfer Format (NTF)—National Transfer Format (mostly used by the UK Ordnance Survey)

K. Spatialite—is a spatial extension to SQLite, providing vector geodatabase functionality. It is similar to PostGIS, Oracle Spatial, and SQL Server with spatial extensions

L. Simple Features—Open Geospatial Consortium specification for vector data

M. SOSI—a spatial data format used for all public exchange of spatial data in Norway

N. Spatial Data File—Autodesk's high-performance geodatabase format, native to MapGuide

O. TIGER—Topologically Integrated Geographic Encoding and Referencing

P. Vector Product Format (VPF)—National Geospatial-Intelligence Agency (NGA)'s format of vectored data for large geographic databases

As set forth above, the information related to the electronic map stored in the storage unit 540 may be generated, stored, and displayed in various formats. Hereinafter, although an example of an electronic map represented in the vector data scheme is described, embodiments of the present invention are not limited to the vector data scheme. Vector data enables various extraction of points, lines, polygons, or such elements, and differently display the same thing upon generating an electronic map. Further, the electronic map-related information stored in the storage unit 540 may variously be defined depending on the organization or scheme of building up the database (DB).

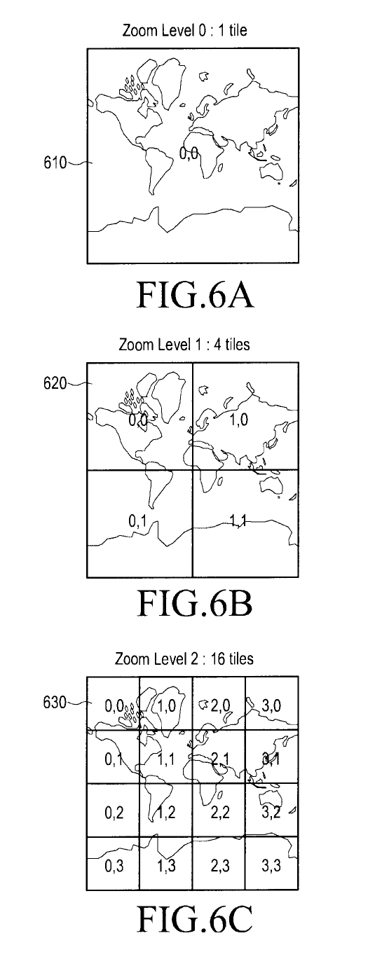

FIGS. 6a, 6b, and 6c are views illustrating tile sections of an electronic map according to various embodiments of the present invention. Referring to FIGS. 6a, 6b, and 6c, an electronic map may be configured so that a set area may be divided into at least one tile depending on the zoom level. For example, different zoom levels of map tiles may be configured depending on map service providers, and various categories of map tiles may be configured, such as map tiles for a particular country or per-city map tiles.

For example, if the zoom level is varied or the location being currently viewed is changed as shown, new tiles are required, and the tiles may be connected together. If the zoom level is relatively low, it may encompass information about a broader area but show simplified area information. In contrast, the zoom level being relatively high may show a narrower area but present more detailed information.

FIG. 6a illustrates that the zoom level is set to 0 so that a particular area may be constituted of a single tile 610. FIG. 6b illustrates the zoom level is set to 1 so that the same area may be constituted of four tiles 620. FIG. 6c illustrates that the zoom level is set to 2 so that the same area may be constituted of 16 tiles 630.

Besides the map tiles, additional information related to the electronic map may be provided. For example, a satellite photo service may show photos that are in the same form as the electronic map but have been actually taken from a satellite or aircraft. The satellite photo-related information may be provided from a database or server different from the electronic map.

In another embodiment, the storage unit 540 may receive and store real-time traffic information from a server (e.g., a map service provider's server or traffic organization's server). The real-time traffic information may be displayed overlaid on the road in the electronic map, and the traffic state may be represented in, e.g., a color. The real-time traffic information may be provided in the map tile information or may be received in real-time in a separate data form.

In another embodiment, the storage unit 540 may receive and store 3D stereoscopic photo information. The 3D stereoscopic photo information may include information obtained by configuring a 360-degree panoramic photo actually taken at a particular point on the map with a 3D-type UI. For example, the information, as a photo taken at a particular point, may be provided to the user.

In another embodiment, the storage unit 540 may receive weather/meteorological information. A photo taken of a cloud by the satellite, as the weather/meteorological information, may be displayed overlaid on the map. Or, weather, temperature, or event information received from a weather information providing server (e.g., a server of the National Weather Service) may be displayed overlaid on the electronic map.

On top of that, the storage unit 540 may store information related to various services that may then be displayed on the electronic map, such as display as per various themes, display of information as does, e.g., an encyclopedia, or display of photos created by a service provider or user.

The pieces of information may be included in the tiles provided from the electronic map providing server, or they may be received in a type other than that of the map tiles and be displayed overlaid on the electronic map.

According to various embodiments of the present invention, the map component information 541 stored in the storage unit 540 may include components constituting at least part of the electronic map, or text, POIs, roads, or lands as information related to the electronic map.

Further, according to various embodiments of the present invention, the map component configuration information 542 stored in the storage unit 540 may include preset information or information set by the user in relation to the map components.

For example, the information set by the user may be the type of the electronic map that the user desires to view on the electronic map, the type of POIs displayed on the screen, the quality of the electronic map, zoom level, color scheme of the 2D/3D electronic map, or additional information.

The type of electronic map may be divided into, e.g., map for vehicles, map for bicycles, or map for pedestrians, depending on the way the user uses, or may be divided into a satellite map and land map. The type of POI may be a designated POI (e.g., a favorite) the user desires to view or the category (e.g., restaurant) of the POI. The quality of electronic map may be represented as, e.g., a detailed map or brief map, based on the screen resolution or rendering performance. The zoom level may be set to various types of zoom, e.g., a state level, city level, or street level. 2D/3D may determine display of the map according to times. The color scheme of map may be applied as a color depending on whether it is daytime or night mode, display of a color for a particular road/area that the user desires, or a color related to a theme, such as game/movie/product. As the additional information, information, such as traffic information, photos, weather, or clouds, may be displayed on the existing map.

The controller 540 may include at least one of a map component extracting unit 521, a map component reconfiguring unit 522, an electronic map generating unit 523, and a frame processing unit 524.

The map component extracting unit 521 may extract at least one of the map components stored in the storage unit 540.

For example, the electronic map may have various types of layers. The electronic map may be displayed in various types of layers depending on the purposes for the same topography.

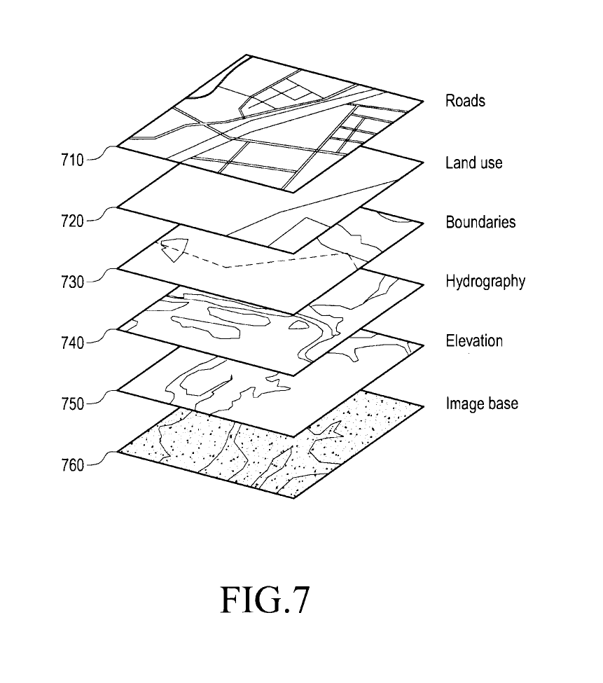

FIG. 7 is a view illustrating various layers of an electronic map according to various embodiments of the present invention. A road layer 710 may display various road information, such as highways, one-way roads, narrow roads, and traffic information. A land use layer 720 may display the uses (e.g., for real property purposes) of lands per area. A boundary layer 730 may display the boarder of a country or administrative district. A hydrography layer 740 may display water district information. An elevation layer 750 may represent altitude information such as contours based on topography information. An image base layer 760 may be a layer that is based on photos actually taken, such as satellite photos.

One electronic map service may include at least one or more layer services. The map component extracting unit 521 may select at least one layer fitting context among the various layers. For example, the land use layer 720 may be selected to extract related information to display land information to display real property information on the map. Information from the elevation layer 750 may be utilized to display mountain information for mountain climbing. Information from the boundary layer 730 may be utilized to form an inter-city border in the area.

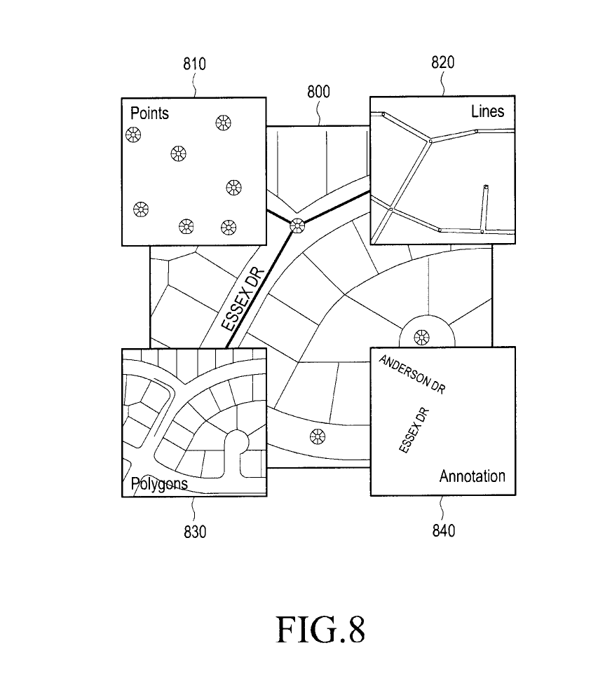

FIG. 8 is a view illustrating a layered structure of an electronic map according to an embodiment of the present invention. According to various embodiments of the present invention, each layer of the electronic map 800 may be constituted of polygons, lines, and points as shown in FIG. 8. A particular business name or landmark such as a POI may be constituted of the layer 810 of points. Basically, road information may be constituted of the layer 820 of lines. Land information may be constituted of the layer 830 of polygons. Further, an administrative district, address, road name, or business name may be constituted of the layer 840 that is text overlaid. Each layer information may be generated in a separate frame buffer by the electronic map generating unit 523 (e.g., a map generation engine) or may selectively be rendered by a graphic engine, constituting a 2D or 3D map.

If at least one map component constituting an embodiment to be generated through the electronic map generating unit 523 is extracted through the map component extracting unit 521, the map component reconfiguring unit 522 may edit or reconfigure the location, size, or the way to display, of the at least one map component extracted or selectively delete at least one map component. The map components may include components, such as text, POIs, roads, or lands, as set forth above.

Further, according to various embodiments of the present invention, the map component reconfiguring unit 522 may select, reconfigure, or vary the extracted map component by pre-designated configuration information included in the map component configuration information 542 stored in the storage unit 540 or configuration information by a user input.

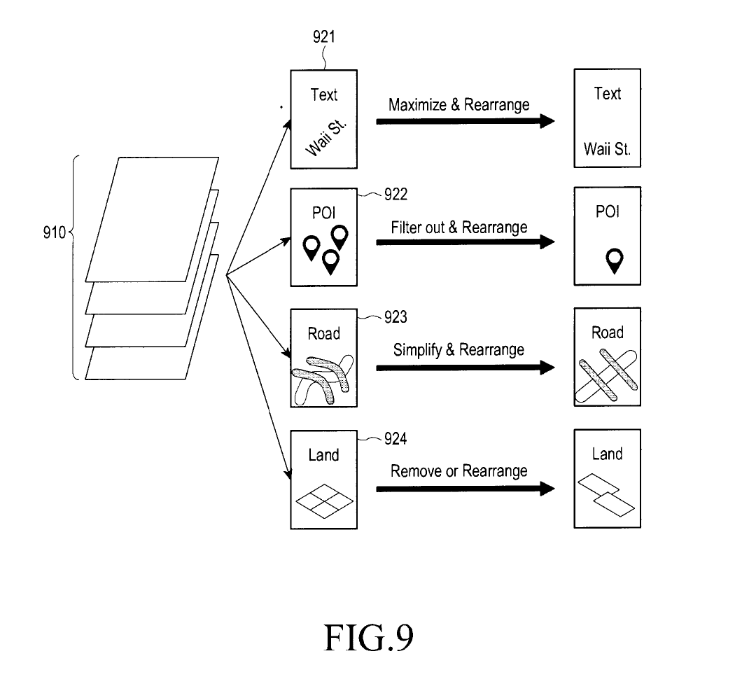

FIG. 9 is a view illustrating examples of simplifying an electronic map according to various embodiments of the present invention. For example, according to various embodiments of the present invention, electronic maps or electronic map may be reconfigured by simplifying or removing at least one extracted map component.

Referring to FIG. 9, the text 921 extracted from at least one layer 910 may be edited to be displayed fitting the screen orientation. Further, the text 921 may be varied into a font or color with more legibility, be designated various effects (e.g., a shadow effect), or the font may be enlarged or shrunken.

According to various embodiments of the present invention, in case of a POI icon 922, the number of POIs to be displayed on the screen may be adjusted depending on the priority or importance of POI. Further, where a plurality of POI icons overlap each other in a narrow area, it may be reconfigured to display only a single POI (e.g., a representative POI) or only POIs favored by the user. Further, the POI icons may also be adjusted to have various sizes depending on settings.

According to various embodiments of the present invention, the road 923 may be reconfigured by linearizing or simplifying a curved road. Further, it may be reconfigured so that small roads may be deleted or hidden from display, rendering larger roads more noticeable. Further, it may be adjusted so that roads are more remarkable by contrasting lands or lots in color, and the thickness of roads may be adjusted depending on settings.

Further, according to various embodiments of the present invention, color contrasts may be made to POIs and text. The land 924 may be adjusted not to display unnecessary buildings, areas, or blocks, and blocks split into pieces may be combined together into a single one and may then be displayed. In the following description, the block which is displayed as blocks are combined together may be denoted a frame. Further, in the following embodiments, at least one POI may correspond to each frame which is displayed as blocks are combined together. If the POI-corresponding frame is selected, an operation related to the corresponding POI (e.g., displaying or requesting relevant information) may be rendered to be performed.

The operation of varying or reconfiguring mcc s by the map component reconfiguring unit 522 may include the operation of simplifying information displayed on the screen. For example, the reconfiguring operation may include the operation of adjusting the size of each map component, the operation of removing small map components to highlight larger map components or to display a displayed image in a simplified manner, the operation of contrasting colors, the operation of relocating, the operation of filtering content displayed, the operation of linearizing curves, or the operation of combining small map components.

According to various embodiments of the present invention, the operations of reconfiguring map components may distort the actual shape. However, such operations may be performed in a range of not deforming the relative arrangements of the map components.

The electronic map generating unit 523 generates electronic map information to be displayed on the screen based on the map component information extracted from the map component extracting unit 521. The map components to generate the electronic map may include layers, text (or annotations), POIs, roads, and lands as set forth above.

Further, according to various embodiments of the present invention, the electronic map generating unit 523 may generate the electronic map information based on map components reconfigured by the map component reconfiguring unit 522. For example, the electronic map generating unit 523 may merge the map components in the frame buffer generated through the frame processing unit 524 on information, such as layers, texts, POIs, roads, and lands which are the map components reconfigured by the map component reconfiguring unit 522.

Further, according to various embodiments of the present invention, the map component information may be rendered by the graphic engine of the electronic device to configure at least one frame in the frame buffer, and the configured frame may be displayed on the screen through the display unit 510.

For example, in the satellite layer information, the image of a particular area may be stored as it is, cut to a designated size or resized, and then stored in the frame buffer. Road information may be displayed in the form of a line based on node and/or link information about road information extracted from the map component extracting unit 521 or may be configured in the form of a normal road, e.g., a special road or real-life form, such as an overpass or underpass, rendered by the graphic engine and may then be displayed in 3D.

According to various embodiments of the present invention, the electronic map may include a commonly used electronic map, or any types of maps or information displaying locations, such as a satellite map, 3D map, or street view map. The electronic map generating unit 523 serves to configure the screen so that the user may view the data extracted from the map component extracting unit 521. Computation for displaying in 3D or stereoscopic types may be carried out by the graphic engine.

Further, according to various embodiments of the present invention, normal raster images, e.g., satellite photos, may also be displayed through the electronic map generating unit 523. The settings of map view may be made in reference to the map component configuration information 542 stored in the storage unit 540.

The electronic map generating unit 523 may further include a graphic engine to generate electronic maps. The graphic engine is an engine to process rendering to generate maps. For example, the graphic engine may be used upon generating modules for a 3D map. Optionally, the graphic engine may not be used. The graphic engine may support both hardware and software and may be used to configure a desired screen by quick computation. Further, according to various embodiments of the present invention, the graphic engine may be configured separately from the electronic map generating unit 523 and to interwork with the electronic map generating unit 523.

The input unit 550 may include an input means, e.g., the touch screen panel (TSP) of the electronic device 500, a stylus pen digitizer, hardware (H/W) keys/buttons, a microphone, or an ear jack. Various settings for generating an electronic map through the input unit 550 may be inputted through a UI.

The display unit 510 may include a display means, such as an LCD, AMOLED, OLED, or e-ink display of the electronic device 500. The display unit 510 may be rectangular as usual, or circular or elliptical. Or, the display unit 510 may be polygonal or shaped as a closed loop.

The display unit 510 may have various resolutions, and the display unit 510 may be flat or curved. Or, the display unit 510 may be bent or crumpled. Further, the display unit 510 may be one of a transparent, translucent, or opaque display.

According to various embodiments of the present invention, the controller 520 may perform computation on the electronic device 500 and may also process various functions to control the operation of the electronic device 500. For example, the controller 520 may be an application processor AP and may be a separate processor designed to consume low power. Or, the controller 520 may be configured in a modem processor or included in a processor of a separate positioning module or communication module.

The communication unit 530 may be a device wiredly or wirelessly communicating with an electronic device other than the electronic device 500 or a server. The other electronic device may be another mobile device or may be an access point (AP) or bluetooth low energy (BLE) beacon that is stationary. Or, the other electronic device may be a base station over a mobile communication network.

According to any one of various embodiments of the present invention, an electronic device may comprise a storage unit storing map components, a controller reconfiguring at least one of the map components stored in the storage unit according to a preset condition and generating an electronic map using the reconfigured map components, and a display unit displaying the generated electronic map on a screen.

According to various embodiments of the present invention, the storage unit may further store map component configuration information, and the controller may reconfigure the map components based on the map component configuration information.

According to various embodiments of the present invention, the map components may include at least one of a text, a point of interest (POI), a road, and a land.

According to various embodiments of the present invention, the controller may simplify and reconfigure the at least one selected map component.

According to various embodiments of the present invention, the controller may reconfigure the at least one selected map component by creating a block for the at least one map component of the electronic map.

According to various embodiments of the present invention, the controller may adjust a direction of display of a text among the at least one selected map component based on an orientation of the screen of the electronic device.

According to various embodiments of the present invention, the controller may vary or resize a font of a text among the at least one selected map component.

According to various embodiments of the present invention, the controller may adjust the number of POIs to be displayed depending on priority or importance of the POIs among the at least one selected map component.

According to various embodiments of the present invention, for a road among the at least one selected map component, the controller may reconfigure the road by linearizing the road that is curved, delete the road to prevent roads below a preset reference from being displayed, reconfigure the road to allow roads above the preset reference to be highlighted, or adjust a thickness of the road according to a setting.

According to various embodiments of the present invention, the controller may form at least one frame by simplifying topography among the at least one selected map component and map at least one piece of POI information to each frame formed.

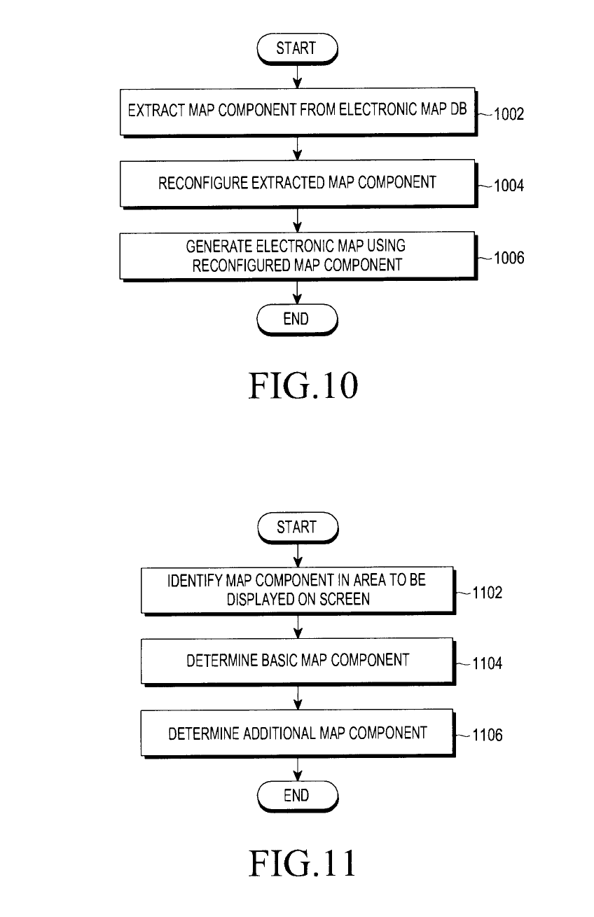

FIG. 10 is a flowchart illustrating a procedure for generating an electronic map according to various embodiments of the present invention. Referring to FIG. 10, in operation 1002, at least one map component may be extracted from a storage unit (e.g., an electronic map database). In operation 1004, the extracted map component may be edited or reconfigured. In operation 1006, the reconfigured map component may be used to generate an electronic map. Various methods for reconfiguring the map components may be adopted according to various embodiments of the present invention, or the map component may be reconfigured according to preset conditions or given the display of the electronic device that is to display the electronic map.

For example, operation 1002 may be the operation of extracting map components based on the map component configuration information 542 stored in the storage unit 540. Operation 1004 may include the operation of reconfiguring the map component extracted to raise the legibility of the map based on the map component configuration information 542 according to various embodiments of the present invention, . Operation 1006 may include the operations of generating an electronic map based on the reconfigured map component, displaying the same, and configuring interoperation with the user.

Hereinafter, each step is described in greater detail.

The map information stored in the storage unit 540 may include a ‘raw data set’ of map components constituting a map. The operation of extracting the map component may include the operations of determining what information is needed and collecting such information to allow the user to more easily grasp (enhance legibility) and understand the information in the map among the raw data set of various map components. For example, the electronic map information may include node, line, polygon, color, and altitude information and pieces of information obtained by giving meanings to such pieces of information to map to roads, buildings, parks, farms, and mountains.

Further, the electronic map information may also include information for a map closer to the service, such as traffic condition of each area, weather, and bus routes. In the operation of extracting from among the various pieces of information above, necessary map components are extracted in the range of not distorting information due to the reduced amount of information while avoiding losses in delivering meanings as a map to the user.

Such extraction of map components may extract map components by which the minimum meaning may basically be delivered and further extract the map components based on the map component configuration information 542 configured by the user.

The operation of extracting the map components in operation 1002 may further include operations shown in FIG. 11. FIG. 11 is a flowchart illustrating a procedure for reconfiguring map components according to various embodiments of the present invention.

Referring to FIG. 11, operation 1102 may include the operation of identifying map components in an area to be displayed on the screen to extract map components.

The area to be displayed on the screen may be varied depending on the size of the screen or resolution display means of the electronic device, the resolution of an electronic map that the electronic device possesses, the size of map tiles, the zoom level configurable by the user, and the orientation of the electronic device. Given them, a polygonal area which is to be displayed on the screen may be determined. If an area supposed to be shown to the user is determined, the controller 520 determines all the map components that may be included in the area in the storage unit 540.

To determine the map component, first in operation 1104, the operation of identifying basic map components to configure a simplified map enough to deliver the meanings may be carried out. Here, the basic map components are components necessary to deliver a clear meaning as a map. For example, although altitude or boundary information pieces may be necessary, they may be unnecessary for daily uses. Further, they may be unnecessary in delivering the overall information on a small-screen wearable device or even hamper the achievement of glance view of the wearable device that targets quick delivery of information. The operation of identifying the basic map components may include the operation of determining essential components, e.g., roads and buildings, while excluding unnecessary pieces of information.

After the operation of identifying the basic map components (first map components), additional map components (second map components) may be determined in operation 1106 based on configuration information or preference information previously set by the user. The determination of the additional map components may include the operation of deleting information belonging to the basic map components or the operation of adding pieces of information that are supposed to be displayed on the map depending on the user's preference. For example, although traffic information is included as one of the basic map components, it may be deleted as per the user's preference, or in contrast, traffic information, even if it does not belong to the basic map components, may be added.

Referring back to FIG. 10, the reconfiguration information of operation 1004 may include the operation of modifying or reconfiguring map components chosen focusing on the increase in user legibility for the additional map components as per the user preference information and the determined basic map components. In such modification or reconfiguration operation, a reconfiguration (or reformation) operation proceeds according to the semantics that the map is supposed to represent, e.g., distance, POI, route, context, time, building size/property, or personal preference.

For example, distance-based reconfiguration is taken as an example according to various embodiments of the present invention. The most critical location where the significant meaning is delivered to the user viewing the map may be the user's current location. From a point of view of semantics, information about the surroundings of the current location may thus be said to have a more value when displayed on the map than information about a location far away from the current location. Therefore, to represent material information without missing the overall context (e.g., directivity, e.g., the current location relative to a particular location) of viewing the map, the location near the current location may be enlarged or reconfigured to a normal size so that detailed information may be delivered while performing such reconfiguration as omitting information or changing the magnification or scale on information as it goes away from the current location.

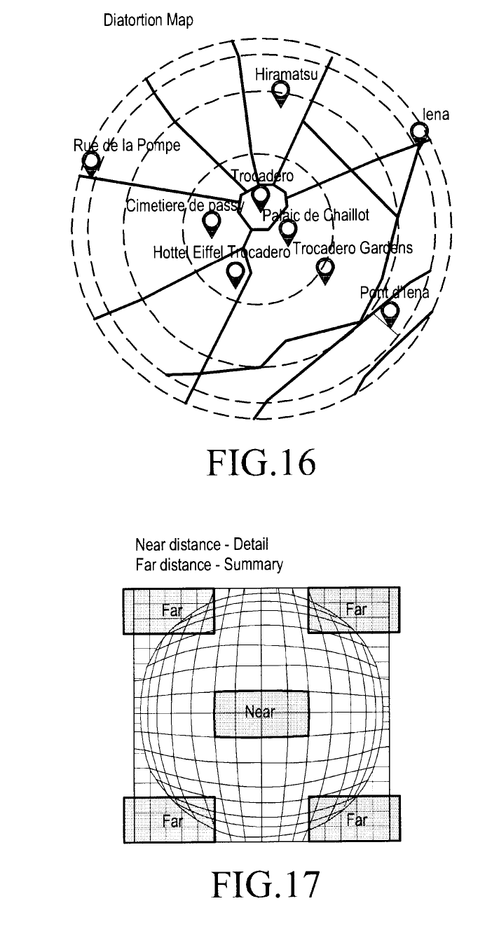

To achieve this, each map component may be transformed proportionally in distance from the current location or per area. When the area to be displayed on the screen represents an area which is 50 km long horizontally/vertically, the road which reaches 25 km along straight line from the current location, which is the center, may be sectioned into several pieces, and pieces may be divided at different scales depending on distance. The same is true for buildings. Only building information about necessary parts, rather than all the buildings, may be rendered to be displayed to fit the sectioned roads. For example, information may be delivered while maintaining the overall map context by reconfiguring the map as if it is viewed through a convex lens placed on the map as shown in FIG. 16 or 17. Detailed embodiments of the reconfiguration will be described below.

According to various embodiments of the present invention, map components may be reconfigured according to contexts. The context-based reconfiguration may be said to vary the map components depending on the time/spatial environment where the user is located, and various such contexts may be present, e.g., place, destination, arrival time, spare time, available wireless connectivity means, nearby wireless LAN, wireless LAN intensity, and device condition. Upon using the context “spare time,” an example may be assumed in which the user departs from a bus terminal. Assuming, at this time, that a section of the electronic map to be displayed on the electronic device is an indoor map for the bus terminal, map components supposed to be displayed on the corresponding map would be ticket offices, a platform, convenient stores, shops, bookstores, food courts, or theaters.

In displaying the indoor map of the bus terminal, the electronic device may compute the remaining time to the departure time of the bus for the user and reflect the same on the display of the map. For example, if there is no roomy time to the departure time, the electronic device may highlight (e.g., thickening, coloring, or flickering) only the location of the platform and the ticket office among the map components mentioned above while deleting the other map components or rendering, although displaying, the other map components less noticeable as compared with the communications determined to be material. In contrast, when the user has spare time, the convenience store, food court, or other places that the user would visit in the spare time may be displayed highlighted while displaying the ticket office and platform location. By so doing, the user may immediately obtain map information corresponding to the issue that he/she should first address now.

In the reconfiguration operation, as set forth above, each communication may be processed to fit the purposes of display, and the actual representation on the map is performed in the following operations based on the reconfigured map components.

The operation of generating an electronic map, operation 1006, may include the operation of rendering map components modified by the reconfiguration in a predetermined area. Such rendering may be reflected not once but whenever events occur, such as moving the map or changing the search location by the user or the user's relocation.

Further, according to various embodiments of the present invention, additional interaction may be set for the map components present on the map along with the rendering and display of the electronic map to avoid the user from bothering manipulation while simultaneously and efficiently delivering information even on small-size electronic devices. This may vary depending on the type of reconfiguration.

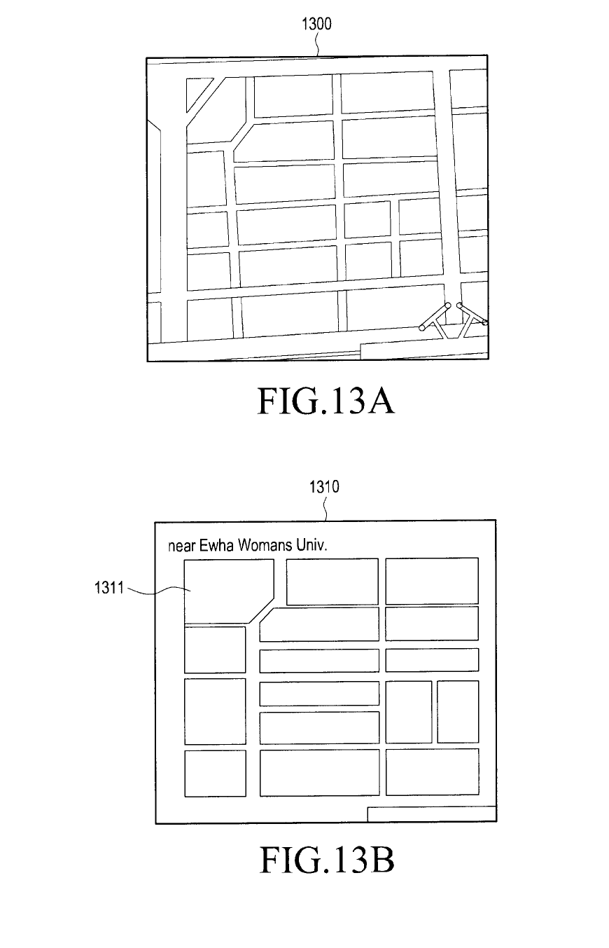

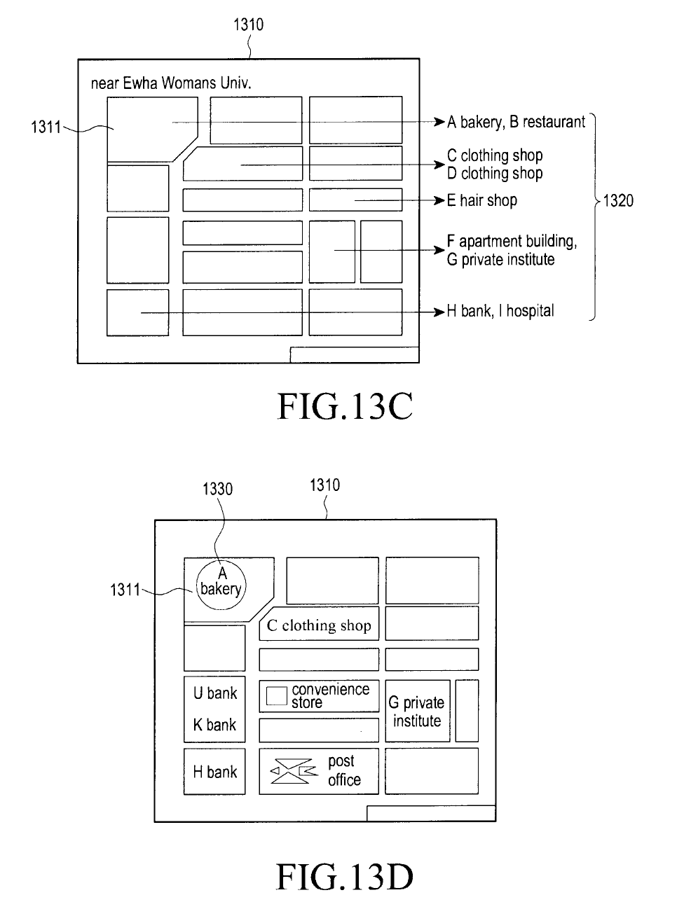

For example, a POI thumbnail-type electronic map described below in connection with FIG. 13 may be taken as an example. Typical maps are mostly flat, rendering it difficult to contain a plurality of pieces of information in the overlapping positions. Further, such difficulty may add more as the screen size is limited as are wearable devices. Even in the context, a POI thumbnail-type electronic map, as one of various embodiments of the present invention, may be operated in such a manner that, where two or more POIs are included in a major building after undergoing the reconfiguration operation for simplification, a plurality of pieces of POI information are varied over time and displayed on the area corresponding to the area size of the building (e.g., the area is denoted as a ‘frame” in the detailed description of the present invention).

Further, such user interoperation may be set that if the POI is displayed on the screen, the user may select the displayed POI (e.g., selecting the frame displaying the POI) to obtain detailed information (e.g., phone number, address, or pictures) about the selected POI. According to the above settings, the user may be avoided from the hassle of manipulating and checking on the small screen in several steps.

The operation of generating an electronic map and the interoperation enables rendering in a predetermined display area of the map components chosen by the extracting operation and modified for easier delivery by the reconfiguring operation. Further, a link is also formed which is a UI capable of providing convenience depending on the map and the rendering. The link may be connected to, e.g., an information page, detailed map, contact list, homepage, destination settings, or location sharing of the map components.

At least one of the operations shown in FIGS. 10 and 11 may be omitted, and at least one other operation may be added between the operations. The operations shown in FIGS. 10 and 11 may be processed in the order as shown, or at least one of the operations may be processed in a different order. Further, the operations shown in FIGS. 10 and 11 may be performed in the electronic device or server. Such an implementation may be made that at least one of the operations shown in FIGS. 10 and 11 is performed in the electronic device while the other operations are performed in a server.

According to any one of various embodiments of the present invention, a method for displaying an electronic map on an electronic device may comprise the operations of selecting at least one of map components constituting the electronic map, reconfiguring the at least one selected map component according to a preset condition, and generating the electronic map using the reconfigured map component.

According to various embodiments of the present invention, the reconfiguring operation may reconfigure the map component based on preset map component configuration information.

According to various embodiments of the present invention, the map components may include at least one of a text, a point of interest (POI), a road, and a land.

According to various embodiments of the present invention, the reconfiguring operation may simplify and reconfigure the at least one selected map component.

According to various embodiments of the present invention, the reconfiguring operation may reconfigure the at least one selected map component by creating a block for the at least one map component of the electronic map.

According to various embodiments of the present invention, the reconfiguring operation may adjust a direction of display of a text among the at least one selected map component based on an orientation of the screen of the electronic device.

According to various embodiments of the present invention, the reconfiguring operation may vary or resize a font of a text among the at least one selected map component.

According to various embodiments of the present invention, the reconfiguring operation may adjust the number of POIs to be displayed depending on priority or importance of the POIs among the at least one selected map component.

According to various embodiments of the present invention, for a road among the at least one selected map component, the reconfiguring operation may reconfigure the road by linearizing the road that is curved, delete the road to prevent roads below a preset reference from being displayed, reconfigure the road to allow roads above the preset reference to be highlighted, or adjust a thickness of the road according to a setting.

According to various embodiments of the present invention, the reconfiguring operation may form at least one frame by simplifying topography among the at least one selected map component and map at least one piece of POI information to each frame formed.

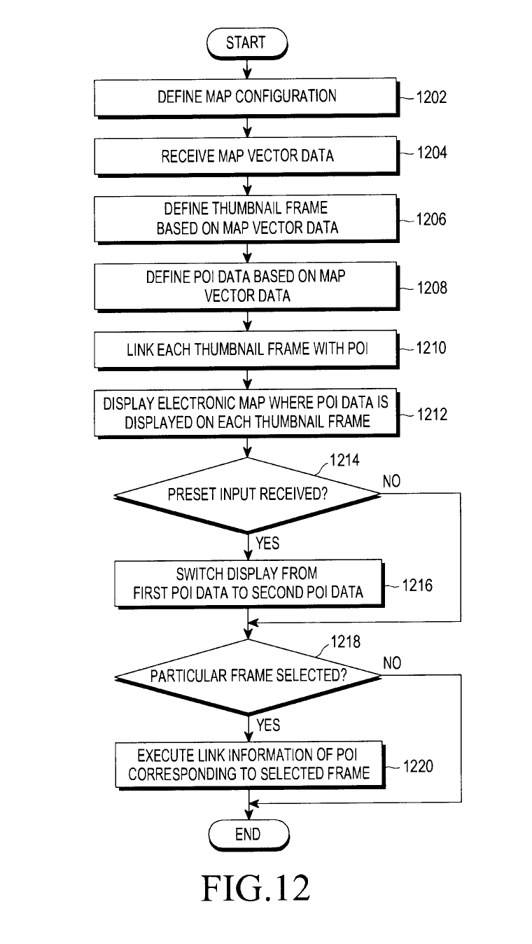

Now described are other methods for generating an electronic map according to various embodiments of the present invention, with reference to FIGS. 12 to 32.

FIG. 12 is a flowchart illustrating a procedure for displaying an electronic map with POI thumbnail-based frames according to various embodiments of the present invention. In the following embodiments, ‘frame’ may mean a particular area on an electronic map or the overall area of the electronic device, but may variously be defined according to various embodiments of the present invention, . For example, ‘frame’ may mean a particular geographical component simplified on the electronic map. Further, in the following embodiments, the term ‘thumbnail’ is one used to assist in an easier understanding of the present invention but not to limit the present invention.

Referring to FIG. 12, map information may be configured in a user interface UI to allow the user to easily select a particular POI. For example, simplified unit areas (e.g., blocks) on the map may be defined as frames, and at least one POI may be mapped to each frame. The user may easily select a POI by selecting a particular frame.

In operation 1202, a map configuration may be defined. For example, according to various embodiments of the present invention, configuration information on the map may be defined, and the defined configuration may include configurations, such as coordinates, zoom level, or radius of the area selected on the map.

The map configuration information may be brought from the map component configuration information 542 of the storage unit 540. Which one is to be selected from among one or more configured frame themes, and the theme may be configured as a POI set. For example, as types of the theme, a theme for showing a store selling the user's desired goods, a theme for showing a restaurant, a theme for showing a place related to health, e.g., fitness or wellbeing, a theme for showing advertisements, and a color or frame shape for representing each frame in a graphical user interface (GUI) may be defined.

Further, according to various embodiments of the present invention, a criterion may be determined to constitute the individual frames. A predetermined size or more of area may become the criterion. For example, the criterion constituting the frame may be set as an area with a particular width or height of pixel unit or more. Further, the criterion constituting the frame may be set as an area with a distance actually measured on the map which is defined as a particular distance (m or mile) or more. Further, the criterion constituting the frame may be set as an area according to the classification of lanes or roads and the width of roads surrounding an area on the map.

In operation 1204, a map component extracting unit (e.g., the map component extracting unit 521) may receive map components (e.g., map vector data) from an external electronic device or a storage unit (e.g., the storage unit 540) as set forth above. The received data may include road, land, and POI information.

In operation 1206, a frame (e.g., a thumbnail frame) may be defined based on the map vector data. For example, the electronic map generating unit 523 may configure the thumbnail frame from the received map vector data. The thumbnail frame may be configured by the preset criterion constituting an individual frame, and one or more frames (e.g., frame1, frame2, . . . , frame N) may be configured.

In operation 1028, POI data may be defined based on the map vector data. For example, POI data to be displayed on the electronic map may be defined. According to various embodiments of the present invention, the POI may be categorized (into, e.g., restaurant, health, or point of interest) according to criteria preset by the user.

In operation 1210, the POI data may be linked or mapped to each thumbnail frame through content containing a particular function. For example, if a particular thumbnail frame is chosen and a particular POI is selected, a particular application linked or mapped thereto may be executed. For example, if the particular thumbnail frame is selected, a particular webpage may be displayed on a webbrowser, or an Internet search may be done through a search keyword.

According to various embodiments of the present invention, the thumbnail frame may be functionally connected with at least one POI, and a particular thumbnail frame may not be connected with the POI.

In operation 1212, an electronic map constituted of at least one thumbnail frame may be displayed on the screen. POI data may be displayed on each thumbnail frame displayed on the screen, matching the corresponding thumbnail frame. According to various embodiments of the present invention, the POI data displayed may be an image of a representative category (e.g., restaurants or banks) of the POI, a brand image (e.g., a company BI or CI), text, or a regular image.

If a preset input is received or a preset time elapses in operation 1214, the POI data displayed on each thumbnail frame may be converted into other POI data in operation 1216. For example, such an implementation may be made that the POI data displayed on the thumbnail frame is changed from first POI data to second POI data that is then displayed. Further, where several POIs are mapped to one thumbnail frame, the multiple POIs may sequentially be converted multiple times over time and displayed. Also possible is such an implementation that, e.g., a plurality of POIs are displayed on one thumbnail frame and are circulated over time so that different POI data is shown highlighted.

In operation 1218, if the user selects a particular thumbnail frame, link information about a preset POI may be executed in operation 1220. According to various embodiments of the present invention, the particular thumbnail frame may be implemented to execute a function related to the POI displayed on the thumbnail frame upon selection. For example, the function may be executing an application, a browser, or a search as set forth above.

FIG. 13a is a view illustrating map data according to various embodiments of the present invention. FIG. 13b is a view illustrating thumbnail frames according to various embodiments of the present invention. FIG. 13c is a view illustrating POI information per frame according to various embodiments of the present invention. FIG. 13d is a view illustrating thumbnail frames displaying POI information according to various embodiments of the present invention.

As described above in connection with FIG. 12, according to various embodiments of the present invention, an electronic map may be reconfigured and displayed in the form of including at least one thumbnail frame. The thumbnail frame may be generated by extracting map component information from a map database and simplifying the map component information. For example, UI frames may be configured using, e.g., blocks, topography, nature, and roads on the map, and each frame may be displayed linked with POI information.

Referring to FIG. 13a, the map component extracting unit may receive or extract map components (e.g., map vector data) to configure an electronic map 1300 from the storage unit. Referring to FIG. 13b, according to various embodiments of the present invention, at least one thumbnail frame 311 may be defined by simplifying the map component information on the electronic map 1310. For example, curved roads may be linearizeed out, and complicated alleys may be merged into a simplified form or deleted. Accordingly, at least one thumbnail frame may be defined based on the information constituting the roads or blocks on the electronic map.

Referring to FIG. 13c, at least one piece of POI information may be linked or mapped to each of the plurality of thumbnail frames defined. If the electronic map is rendered based on the defined thumbnail frames and POIs, POI information 1330 may be displayed on each thumbnail frame 1311 displayed on the electronic map as shown in FIG. 13d.

Referring back to FIG. 13b, the map component reconfiguring unit may configure at least one thumbnail frame using the information constituting roads or blocks from the received map component data. The block or road information used to configure the thumbnail frame may be one that meets a predetermined level of condition among several blocks or roads.

For example, only two-way, four or more-lane roads may be chosen as areas to section thumbnail frames or one or more blocks constituted of small alleys may be merged into blocks of a predetermined size or more, thereby defining thumbnail frames.

Further, where the road serving as a boundary in constituting the thumbnail frame is curved, it may be linearizeed out by a simplification process according to various embodiments of the present invention.

Further, according to various embodiments of the present invention, complicated polygonal blocks may be configured into simple rectangular polygons. At this time, relative positions between the frames are rendered to remain unchanged in the configured thumbnail frame, maintaining the geographical relationship between the frames. For example, each thumbnail frame may mean substantial location information mapped to the actual map. Accordingly, although the blocks are merged to some degree or partially transformed, the original purpose of the map to show topographical locations remains.

Referring to FIG. 13c, each thumbnail frame 1311 constituting the electronic map 1310 may be mapped to the POI information 1320 of at least one of the map components by the map component reconfiguring unit 522. For example, as shown in FIG. 13c, POI information 1320, such as A bakery, B restaurant, C clothing shop, D clothing shop, E hair shop, F apartment complex, G private institute, H bank, and I hospital, may be mapped to each thumbnail frame. As described above, no POI may be mapped to each thumbnail frame, or one or more POIs may be mapped to each thumbnail frame.

Referring to FIG. 13d, among the POIs 1330 belonging to each thumbnail frame 1311 constituting the electronic map 1310, at least one or more POIs may be displayed. What is displayed at this time may be an icon representing the POI or an image (e.g., restaurants or shops) or text indicating the category. Further, according to various embodiments of the present invention, where a plurality of POIs are mapped to one thumbnail frame 1311, the plurality of POIs may be displayed on the thumbnail frame alternately at predetermined time intervals as set forth above. Further, according to various embodiments of the present invention, such an implementation may be made that a plurality of POIs are displayed on one thumbnail frame, and a particular POI is displayed highlighted according to a preset condition.

The thumbnail frames 1311 may be used in a method for displaying a map on the small screen of a wearable device, e.g., a smartwatch. The wearable device inevitably has a smaller screen than the smartphone. Thus, the wearable device is not easy to control with touches, nor is it readily legible. This raises the issue of magnifying the components displayed on the map, but so doing may deteriorate visibility.

According to various embodiments of the present invention, complicated map components constituting an electronic map may be merged and grouped into a simplified form. Further, rather than displaying all pieces of information included in the electronic device, relatively less important components, e.g., small alleys, may be deleted. As shown in FIG. 13d, a thumbnail frame constituting one block shape may serve as a menu button. For example, as set forth above, POI information maped to each block (e.g., a thumbnail frame) may be displayed together on the screen, and the user may choose his/her desired POI by selecting each block (e.g., a thumbnail frame) as if he/she selects on a button menu (or grid menu). Further, the visibility may be enhanced by simplifying the map components of the electronic map, enabling easier check of map information even on watch devices.

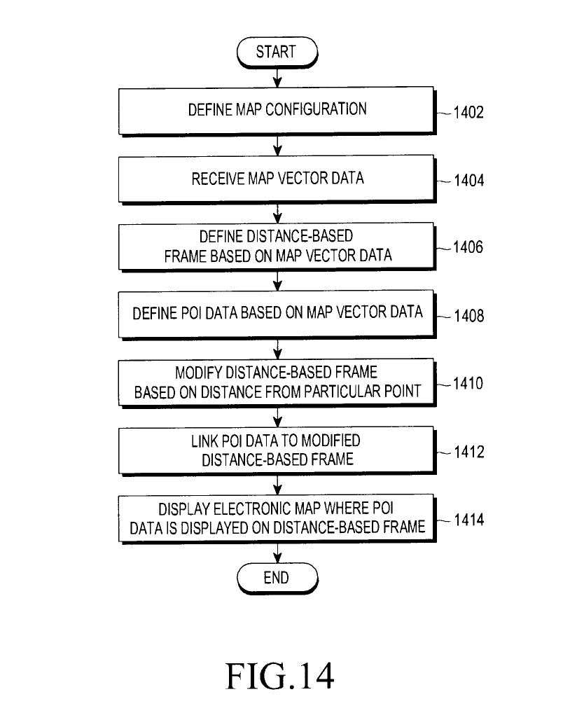

FIG. 14 is a flowchart illustrating a procedure for displaying an electronic map with distance-based frames according to various embodiments of the present invention. According to various embodiments of the present invention, distorted distance frames may provide the function of being able to summarize and display less interested areas while displaying in a further detailed manner more interested areas by distorting and displaying map components according to distances on the electronic map.

Referring to FIG. 14, a map configuration may be defined in operation 1402. For example, according to various embodiments of the present invention, configuration information on the map may be defined, and the defined configuration may include configurations, such as coordinates, zoom level, or radius of the area selected on the map.

The map configuration information may be brought from the map component configuration information 542 of the storage unit 540. For example, the map component configuration information 542 may include information for setting the degree of POI to be displayed on the distorted distance frame. For example, it may determine whether to display POIs with respect to the current location according to the distance between the current location and the POI or to display POIs so that they are evenly distributed according to distances. Further, according to various embodiments of the present invention, it may be determined on POIs located a preset distance or more away what distance of POIs the display is to be performed up to.

In operation 1404, a map component extracting unit (e.g., the map component extracting unit 521) may receive map components (e.g., map vector data) from an external electronic device or a storage unit (e.g., the storage unit 540) as set forth above. The received data may include road, land, and POI information.

In operation 1406, a frame (e.g., a distorted distance-based frame) may be defined based on the map vector data. For example, the electronic map generating unit 523 may configure the distance-based frame from the received map vector data. The distance-based frame may be configured by the preset criterion constituting an individual frame, and one or more frames (e.g., frame1, frame2, . . . , frame N) may be configured according to distances from the middle point.

In operation 1408, POI data may be defined based on the map vector data. For example, POI data to be displayed on the electronic map may be defined. According to various embodiments of the present invention, the POI may be categorized (into, e.g., restaurant, health, or point of interest) according to criteria preset by the user.

In operation 1410, the DDF of the distance-based frame may be modified (or varied) based on the distance from a particular point. For example, the category of the distance-based frame may be defined in the map component configuration information 542 of the storage unit 540. For example, where a point closer to the current location is frame 1, and the farthest point is frame N according to various embodiments of the present invention, the map vector data included in the frames on the map may be reduced towards frame N while keeping frame 1 unchanged.

For example, if the respective sizes of the frames are 1, 2, 3, 4, . . . , the size of display of the same map vector data may be reduced, such as 1, 1.9, 2.7, 3.4, . . . in the distorted distance-based frames according to an embodiment of the present invention.

Or, according to various embodiments of the present invention, frame N may remain unchanged while the map display area displayed is relatively enlarged towards frame 1. For example, if the same map vector data has been displayed on the frames of sizes 1, 2, 3, and 4, the frames may be distorted in size and reconfigured to frames having sizes 1.9, 2.8, 3.5, and 4. At this time, the frame of size 1 before distortion and the frame of size 1.9 after distortion have the same amount of map information, and they may display the same.

Defining he size of a frame in such a manner as to enlarge the middle area or shrink the outer border area would present the maps with the same overall area such an effect that relatively more necessary portions may be shown in further detail while less necessary portions may be briefly shown.

In operation 1412, POI data may be linked to the modified distance-based frame. If the area of the distance-based frame is changed as above, the POI mapped to each frame before distorted by the electronic map generating unit may also be redefined for location to the area fitting the modified size of the frame area and displayed. For example, the coordinates of the POI on the map may be changed from (x, y) to (x′, y′).

In operation 1214, the electronic map including the plurality of distance-based frames may be displayed on the screen, the redefined POI may be displayed on the new distance-based frame.

According to various embodiments of the present invention, distorting map components means changing the location or size on the map that represents the precise location. However, it is not such degree of distortion as to render the location totally illegible and may be provided in the form of summarizing a certain part and highlighting a certain part in a user-acceptable level from a symentics point of view.

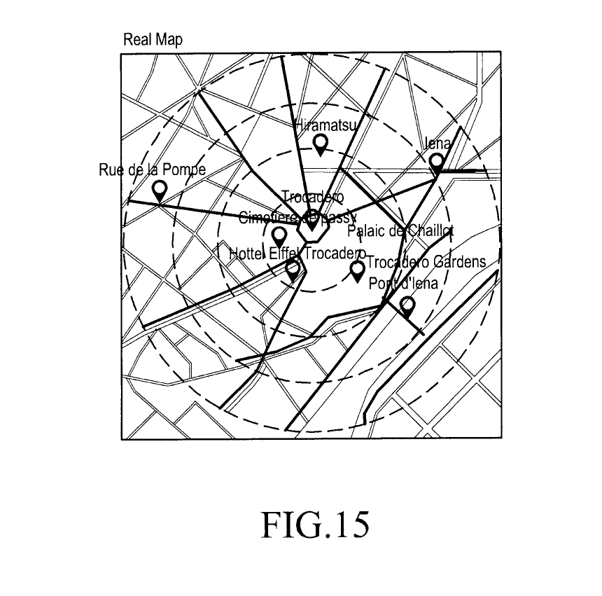

FIG. 15 is a view illustrating an electronic map before distorted according to various embodiments of the present invention. FIG. 16 is a view illustrating a distorted electronic map according to various embodiments of the present invention. FIG. 17 is a view illustrating the concept of a distorted electronic map according to various embodiments of the present invention.

For example, referring to FIG. 15, a map of Paris, France, is shown before distortion. According to various embodiments of the present invention, if the plurality of frames included in the electronic map shown in FIG. 15 are distorted to distance-based frames, the results may be shown as in FIG. 16. That is, according to various embodiments of the present invention, the electronic map including the distorted distance-based frames may be distorted so that the middle part is enlarged while the edge is shrunken as shown in FIG. 17 as if it is when looking to a convex mirror.

For example, the map of FIG. 15 is a map for Paris, France, and the user's current location may be near the center, i.e., the Arc de Triomphe, of the map. Generally, when the user sees the map, the user may have more interest in the POI information about the surroundings of the current location. Accordingly, many people may desire to magnify the map to look into the ambient information in further detail. However, excessively magnifying the electronic map on the limited screen size electronic device, such as watch-type wearable device, may render it difficult to look through the overall area that is broad, so the user may lose the sense of location.

Thus, the POI information may be distorted for relative distance based on the current location as shown in FIG. 17. Although FIGS. 15 and 16 illustrate the maps of the same area, the map of FIG. 16 shows in more detail the surrounding area of the current location, with respect to the current location. In other words, the surroundings of the current location are shown in the same manner while all the topography of a broader area may briefly be shown. That is, according to various embodiments of the present invention, a closer area may be shown in detail while a far area may briefly be shown. Thus, more meaningful map information may be provided at a time.

This may work as a method of being able to provide a lot of meaningful POI information to the user on the small screen such as that of a watch-type wearable device. Referring back to FIG. 15, conventional electronic maps overlap POIs in the area closer to the center in displaying POIs around the user, deteriorating visibility. However, referring to FIG. 16, according to various embodiments of the present invention, as the location of the POIs is distorted so that the POIs around the center are spread and displayed, more visibility can be achieved.

As described above, the distance-based frame enables effective arrangement of POIs in wearable devices with a limited screen size, imprinting essential POI information on the user's mind For example, a restaurant around the current location and another restaurant far away from the current location, notwithstanding that both are anyway restaurants, may have different values. Or, if the user excessively magnifies the map to look into as detailed information about his/her surroundings as possible upon checking POIs on the screen of the watch-type wearable device while walking around the street, the user may lose the sense of direction with the result of difficulty in figuring out the location. In such case, the distorted distance-based frame may show POIs focused on ambient information in the middle while showing major land marks (e.g., the Eiffel Tower in Paris, or the Empire State Building in N.Y.) as goes to the border as set forth above, allowing the user to intuitively identify the location without losing the sense of direction, according to various embodiments of the present invention.

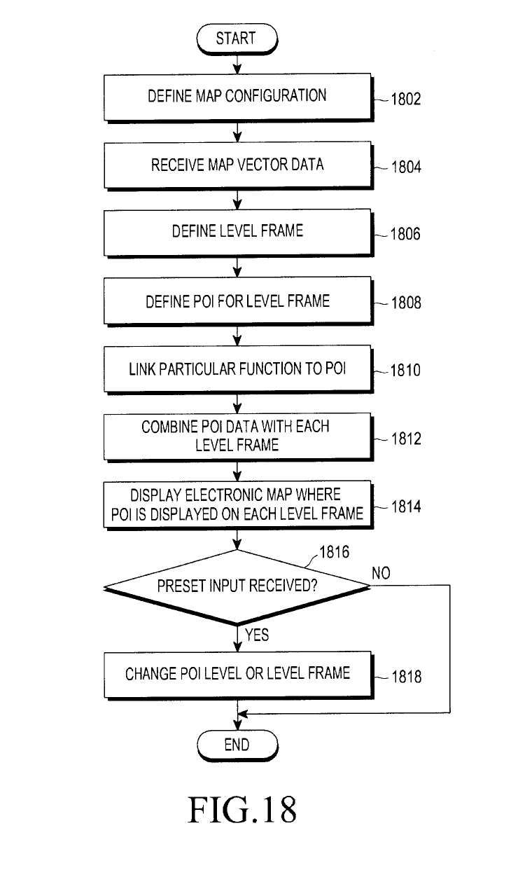

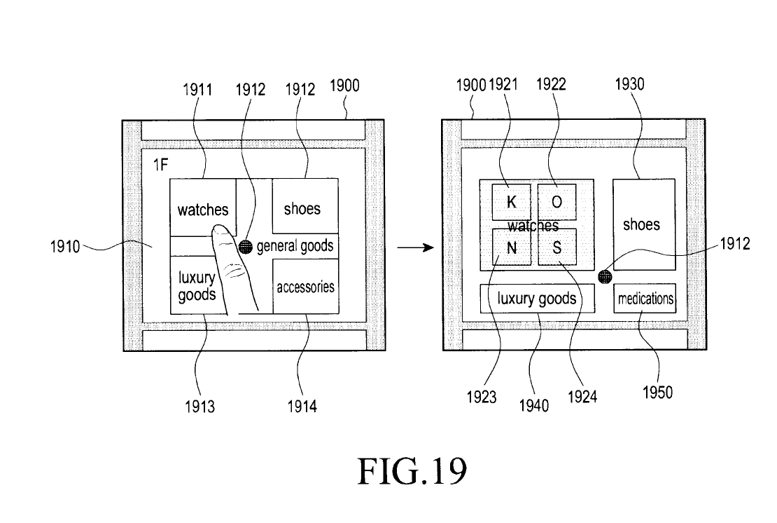

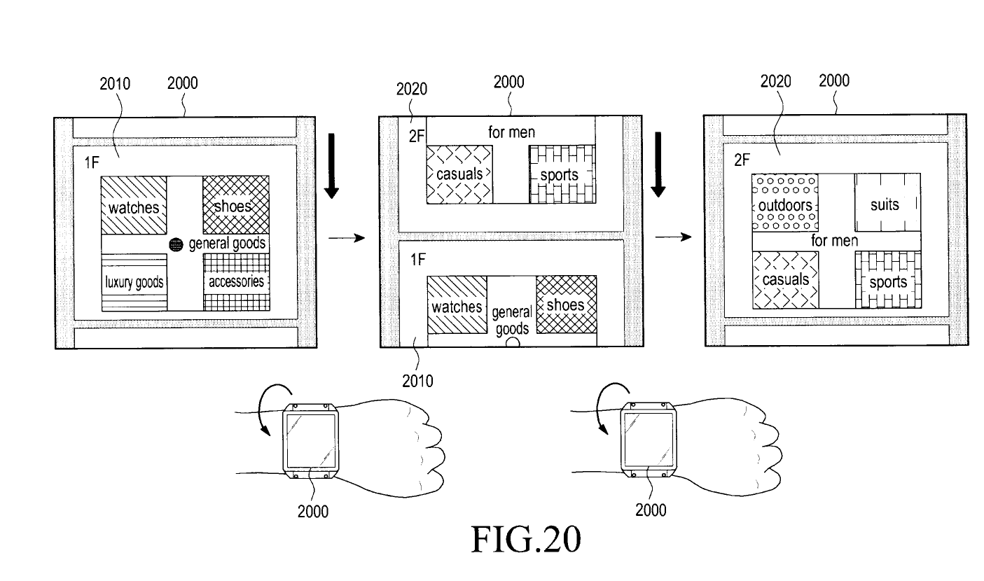

FIG. 18 is a flowchart illustrating a procedure for displaying an electronic map with level frames according to various embodiments of the present invention. FIG. 19 is a view illustrating an electronic map with level frames according to various embodiments of the present invention. FIG. 20 is a view illustrating an example of switching level frames according to various embodiments of the present invention.

According to various embodiments of the present invention, the level frame function may be a function a lot useful for indoor use, which may be implemented to display detailed information as necessary while displaying only main section information or so, rather than all the information, e.g., information about shops on each floor in a building, on the screen of the electronic device with a limited size screen, e.g., a watch-type wearable device.

Each level frame intended for the following embodiments represents an electronic map corresponding to each floor in the building, and one level frame may be implemented to include a plurality of frames (or blocks).

Referring to FIG. 18, a map configuration may be defined in operation 1802. For example, according to various embodiments of the present invention, configuration information on the map may be defined, and the defined configuration may include configurations, such as coordinates, zoom level, or radius of the area selected on the map. Further, according to various embodiments of the present invention, user settings for the map application being currently executed may be defined. If the user starts the map application, default user settings may be loaded.

In operation 1804, a map component extracting unit (e.g., the map component extracting unit 521) may receive map components (e.g., map vector data) from an external electronic device or a storage unit (e.g., the storage unit 540) as set forth above. The received map vector data may include building-related information, building floor information, and information regarding shops in the building.

In operation 1806, a frame (e.g., a level frame) may be defined based on the map vector data. For example, the electronic map generating unit 523 may configure the level frame from the received map vector data. For example, the level frame appropriate for displaying on the watch-type wearable device may be generated. For example, where lots of hallways or passages are there on the floor, it may be reconfigured so that only major ones are left while the others are removed.

Further, according to various embodiments of the present invention, a level frame and another level frame may be connected to be shown as seamless. For example, as shown in FIG. 20, as a first floor level frame is directly connected with a second floor level frame, if a designated input (e.g., a drag, touch, hovering, or motion sensor input) is applied to the first level frame, the second level frame may be displayed.

In operation 1808, POI data for level frames may be defined based on map vector data. For example, POI data to be displayed on each level frame of the electronic map may be defined. According to various embodiments of the present invention, the POI may be categorized (into, e.g., restaurant, health, or point of interest) according to criteria preset by the user.

According to various embodiments of the present invention, if several shops included in the level frame corresponding to each floor are merged and varied into one section (e.g., a frame), a representative POI for the merged section may be defined. For example, several stores selling shoes for men may be grouped and changed into a single section, and its representative POI may be defined as shoes for men.

In operation 1810, the POI data may be linked or mapped to at least one frame included in each level frame through content containing a particular function. For example, if a particular area or section in the particular level frame is chosen and a particular POI is selected, a particular application linked or mapped thereto may be executed. For example, if the particular area or section is selected, a particular webpage may be displayed on a webbrowser, or an Internet search may be done through a search keyword.

In operation 1812, the POI data may be combined with the level frame. For example, the POI may be displayed in each block area or section included in each level frame, and in operation 1814, the POI combined with each level frame may be displayed. If the user selects the displayed POI, a designated operation may be performed.

Upon receiving a preset input in operation 1816, the level of the displayed POI or the level frame may be varied in operation 1818.

According to various embodiments of the present invention, the level of the displayed POI may be varied depending on map component configurations. For example, such an implementation may be made so that when a need occurs for detailed information about several shops in the section while displaying only section information indicating ‘shoes for men,’ the POI information about the shop may further be displayed.

FIG. 19 illustrates one of various embodiments for the level frame. The level frame 1910 being displayed on the screen 1900 of FIG. 19 is a first level frame that is divided into watches 1911, shoes 1812, luxury goods 1913, and accessories 1914 sections or areas (e.g., frames). The frames may be differentiated for section ranges in colors, e.g., red, green, blue, and yellow, or in shadows.

According to various embodiments of the present invention, the information in the level frame may be varied according to the user's selection or location. For example, where the user selects the watches section or is currently in the watches section, the user may desire to get more detailed information about the watches section. Thus, as shown in FIG. 19, if the user selects the watches 1911 selection, the watches 1911 section alone may partially be enlarged. The watches section partially enlarged may display up to several shops in the watches section (denoted with K 1921, O 1922, N 1923, and S 1924 in FIG. 19(. Further, as the watches section is enlarged, the other sections (the shoes 1930, luxury goods 1940, and medications 1950) may relatively be shrunken for the range of display. At this time, the existing POI strings being displayed may be resized, relocated, or line-broken. Further, all or part of the existing POI strings being displayed may be omitted.

FIG. 20 illustrates one of various embodiments representing connection between level frames. Referring to FIG. 20, a first level frame 2010 corresponding to a first floor in the building may be seamlessly connected with a second level frame 1220 corresponding to a second floor in the building. The first level frame 2010 is being displayed on the leftmost screen of FIG. 20. Part of the second level frame 2020 may be displayed over the first level frame 2010, notifying the user that the second level frame 2010 is there.

Upon receipt of the user's designated input (e.g. slightly dragging down the first level frame, or if the first level frame is currently being displayed on the watch-type wearable device, slightly turning the watch-type wearable device to the body) while displaying the first level frame 2010, the second level frame 2020 only part of which has been being displayed may be displayed more to reach substantially the same ratio as the first level frame 2010 as shown in FIG. 20. That is, it can be shown that the second level frame 2020 has a casual for men section and a sports section. As such, although the user is located on the first floor in the building, the above-described operations may be performed to check the shops located on the second floor.

If the user goes from the first floor to the second floor, the whole of the second level frame needs to display. In such case, upon receipt of the user's designated input (e.g., slightly dragging down the first level frame for a predetermined time or more, or if the first level frame is currently being displayed on the watch-type wearable device, turning the watch-type wearable device to the user's body at a predetermined angle or more, or flipping down the first level frame), the second level frame 2020 may be displayed on a majority of the screen area as shown on the rightmost side of FIG. 20.

As shown in FIG. 20, the highest-level POI in the second level frame 2020 may be men, and the next highest-level POIs may be outdoors, suits, casuals, or sports. Also, above or under the second level frame may be displayed part of the third level frame or the first level frame.

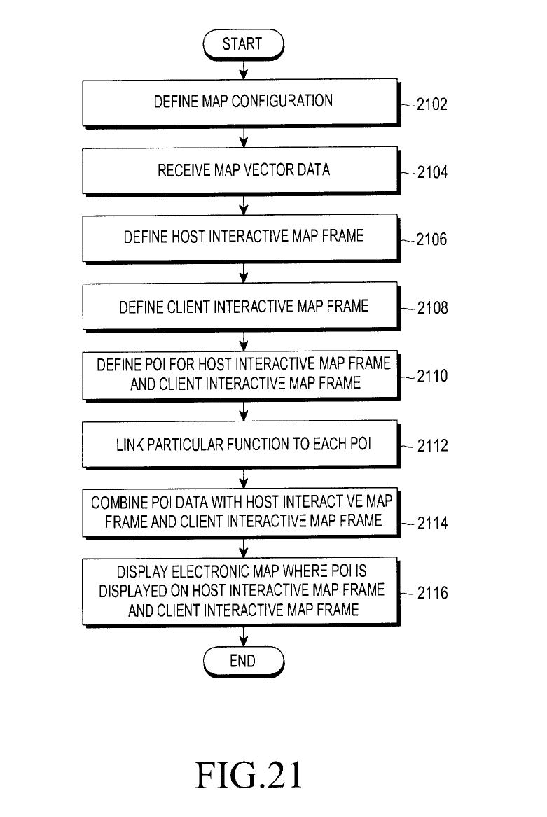

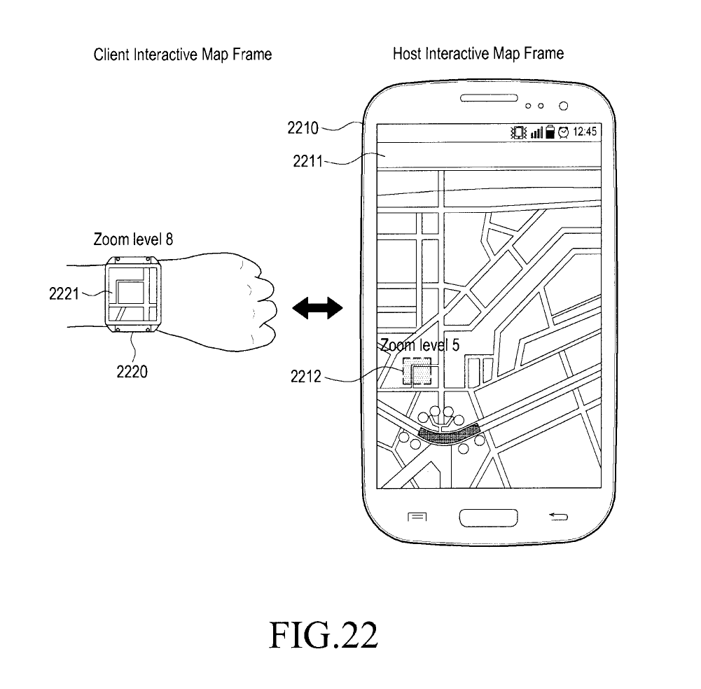

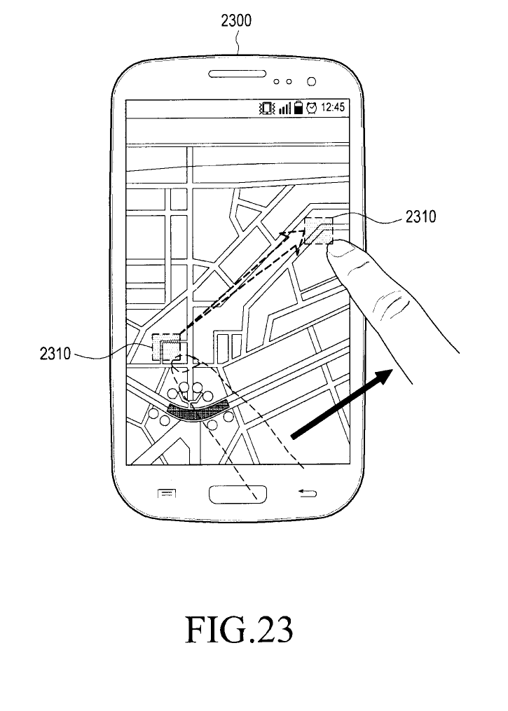

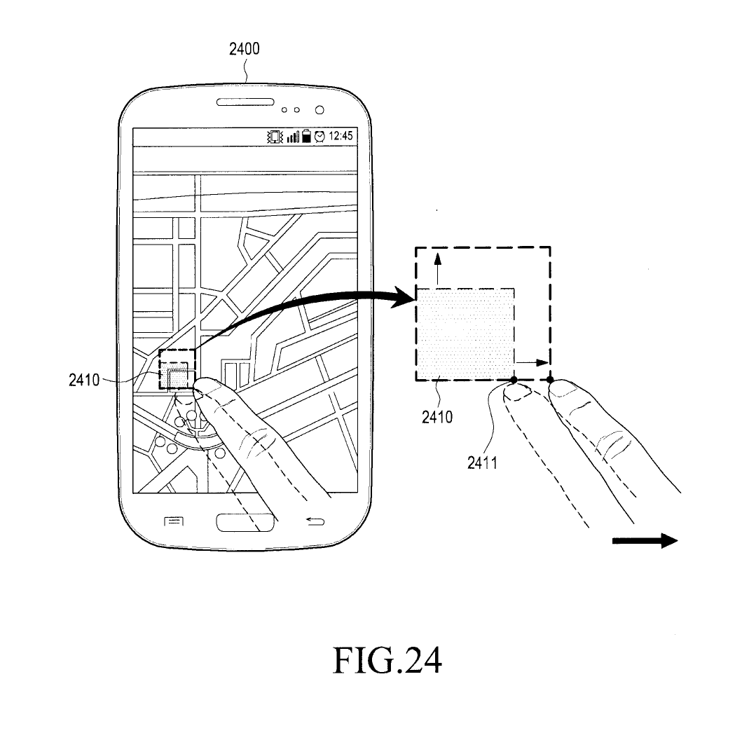

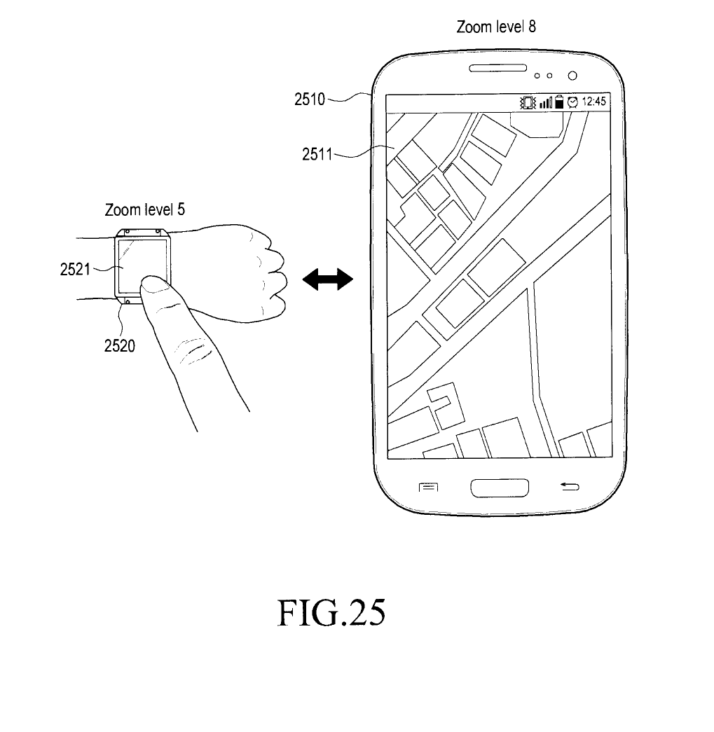

FIG. 21 is a flowchart illustrating a procedure for displaying an electronic map with interactive map frames according to various embodiments of the present invention. FIG. 22 is a view illustrating an example of displaying an electronic map with interactive map frames according to various embodiments of the present invention. FIG. 23 is a view illustrating an example of controlling interactive map frames according to various embodiments of the present invention. FIG. 24 is a view illustrating an example of controlling interactive map frames according to various embodiments of the present invention. FIG. 25 is a view illustrating an example of operating interactive map frames according to various embodiments of the present invention.

According to various embodiments of the present invention, the interactive map frame function means a function by which a plurality of devices may interoperate with each other where the plurality of devices are directly or indirectly connected together. Accordingly, various zoom levels of maps may be displayed in the interctive map frame fitting the features of the device, and content displayed on the map of another device may be controlled through the interactive map frame.

Referring to FIG. 21, a map configuration may be defined in operation 2102. For example, according to various embodiments of the present invention, configuration information on the map may be defined, and the defined configuration may include configurations, such as coordinates, zoom level, or radius of the area selected on the map. Further, according to various embodiments of the present invention, user settings for the map application being currently executed may be defined. If the user starts the map application, default user settings may be loaded.

In operation 2104, a map component extracting unit (e.g., the map component extracting unit 521) may receive map components (e.g., map vector data) from an external electronic device or a storage unit (e.g., the storage unit 540) as set forth above.

In operation 2106, a host interactive map frame may be defined. More specifically, as an example of generating a basic host interactive map frame, if the user configures an interactive mode on, e.g., a map application, a host interactive map frame may be generated.

For example, if a watch-type wearable device connects to a smartphone, a host interactive map frame may be generated. As a more specific example, a host interactive map frame may be generated the moment that an electronic map-related application, e.g., navigation, is executed on the watch-type wearable device.

According to various embodiments of the present invention, the location where the basic host interactive map frame is generated may be the middle of the map being currently displayed on the electronic device or the previous location where it has been being displayed on the electronic map right before termination, or it may be generated with the current location taken as the center of the map.

According to various embodiments of the present invention, the size of the basic host interactive map frame may be a default size designated by the map application, a size randomly set by the user, or the previous size in which the user has adopted before termination.

In operation 2108, a client interactive map frame may be defined.

For example, the zoom level of the client interactive map frame may be determined by a user input. Also, the zoom level of the client interactive map frame may be determined by a device connected. Also, the zoom level of the client interactive map frame may be varied depending on the zoom level of the current display performed by the map application of the smartphone.

According to various embodiments of the present invention, where the zoom level used for the map application being executed on the smartphone is level 5, the zoom level used on the watch-type wearable device may be set as 8. In such case, the zoom level of the host interactive map frame may become level 5 which is the same as the smartphone, and the zoom level of the client interactive map frame may become level 8 which is the same as the watch-type wearable device.

In operation 2110, POIs for the host interactive map frame and the client interactive map frame may be defined. For example, POIs may be defined which are appropriate for display on the host interactive map frame and the client interactive map frame. Since the host interactive map frame and the client interactive map frame may have different zoom levels, the POI to be displayed may be varied, and the POI level may also be varied.

In operation 2112, a particular function may be linked to the defined POI. For example, a particular function may be linked to the POI so that various functions may be connected where the user selects a particular POI.

For example, a designated application may be linked and executed, and access may be made to a designated website. Or, the corresponding POI may be used as a search keyword to do search.

In operation 2114, POI data may be combined with the host interactive map frame and the client interactive map frame. For example, the interactive map frame and the POI data may be combined together so that the POI data may also be displayed when the host interactive map frame and the client interactive map frame are displayed on the screen.

In operation 2116, POIs may be displayed on the host interactive map frame and the client interactive map frame, displaying the electronic map. For example, such an implementation may be made that POIs combined with the host interactive map frame and the client interactive map frame are displayed, and when a particular POI is selected, a designated operation is performed.

FIG. 22 illustrates one of various embodiments for interactive map frames applied to a watch-type wearable device. Referring to FIG. 22, the user is using a map application 2211 at level 5 on the smailphone 2210. To look into a particular area in detail, the user needs to increase the zoom level of the map application 2211. To increase the zoom level, a pinch zoom operation may be performed. The user does a pinch zoom with one hand while holding the smailphone with the other hand This is inconvenient. Increasing the zoom level by the pinch zoom, however, the user cannot see the other areas than the area where he/she intends to look in detail. For example, if the user increases the zoom level to look in detail the inside of the rectangular area 2212 shown in dotted lines in FIG. 22, the existing area which has been being shown may be hidden.

According to various embodiments of the present invention, the interactive map frame may be used in FIG. 22. If the user executes the map application or activates the interactive mode configuration on the map application, a host interactive map frame may be generated in the user's smartphone 2210. The host interactive map frame may have the same zoom level as the map being displayed on the smartphone 2210. A client interactive map frame may be displayed on the watch-type wearable device 2220. The zoom level of the client interactive map frame may differ from the zoom level of the host interactive map frame.

In FIG. 22, the zoom level of the interactive map frame may be level 8. To look in detail a particular area 222 in the electronic map 2211 displayed on the screen of the smartphone 2210, the user may move the host interactive map frame to the corresponding area. In FIG. 22, the host interactive map frame may be the rectangular area 2212 shown in dotted lines. Further detailed level information about the area included in the dotted rectangular area 2212 may be identified from the client interactive map frame.

For example, the area in the host interactive map frame may be displayed in more detail at level 8 in the client interactive map frame 2221 displayed on the watch-type wearable device 2220 of FIG. 22. As such, the user may magnify and see only his/her desired area without the need for magnifying the overall map or separate manipulation on the smartphone 2210 using both hands.

FIG. 23 illustrates an example of controlling an interactive map frame. As shown in FIG. 23, if the user drags the host interactive map frame 2310 to a desired area with his/her hand to magnify and display the host interactive map frame 2310 on the electronic map displayed on the screen of the smartphone 2300, the area corresponding to the final location of the host interactive map frame 2310 may be magnified and displayed on the client interactive map frame.

Further, as shown in FIG. 24, the size of the host interactive map frame may be changed. Referring to FIG. 24, if an edge or vertex 2411 of the host interactive map frame 2410 of the electronic map displayed on the screen of the smartphone 2400 is dragged, the host interactive map frame 2410 may be resized as much as the drag.

According to various embodiments of the present invention, the host interactive map frame may have a minimum and maximum size value. For example, if the size of the host interactive map frame 2410 increases, information about a relatively broader area may be displayed on the client interactive map frame.

FIG. 25 illustrates one of various embodiments of interactive map frame operations. The user executes a map application on the watch-type wearable device 2520 to display an electronic map on the touchscreen 2521. In this state, the user may desire to view the map in more detail on a bigger screen. In such case, the interactive map frame may be put to use.

Referring to FIG. 25, the user is using the map application at level 5 on the watch-type wearable device 2520. At this time, when the user desires to view, on the smartphone 2510, a further detailed map for the portion being displayed on the touchscreen 2521 of the watch-type wearable device 2520, the user may perform a designated operation on the watch-type wearable device 2520. Here, the designated operation may be tapping on the touchscreen 2521 of the watch-type wearable device 2520.

Or, according to various embodiments of the present invention, where the user holds the smartphone with the hand having the watch-type wearable device 2520 worn, the designated operation may be turning his hand to the outside to see the smartphone 2510. If such operation is inputted, the map information 2511 of a higher level than the zoom level of the display on the client interactive map frame may be displayed on the smartphone 2510.

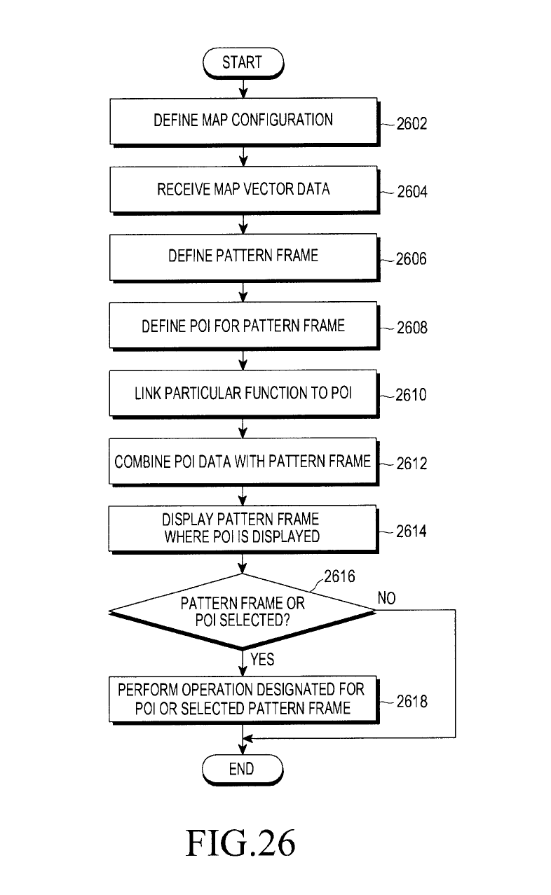

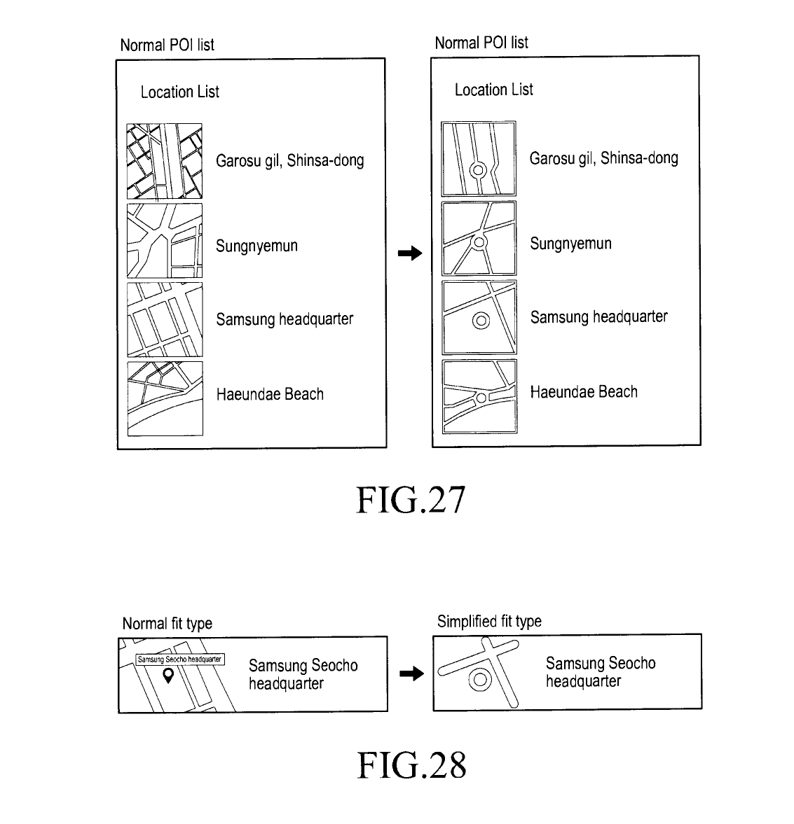

FIG. 26 is a flowchart illustrating a procedure for displaying an electronic map with pattern frames according to various embodiments of the present invention. FIG. 27 is a view illustrating an example of displaying an electronic map with pattern frames according to various embodiments of the present invention. FIG. 28 is a view illustrating an example of displaying an electronic map with pattern frames according to various embodiments of the present invention.

According to various embodiments of the present invention, the pattern frame function is a function of highlighting a corresponding place by displaying only POI information about an attraction while simplifying the surroundings of the POI, e.g., the attraction. According to various embodiments of the present invention, when the user jogs with a sports functions specified wearable device worn on, he or she may be aware where he or she is at a mere glance at the wearable device.

Referring to FIG. 26, a map configuration may be defined in operation 2602. For example, according to various embodiments of the present invention, configuration information on the map may be defined, and the defined configuration may include configurations, such as coordinates, zoom level, or radius of the area selected on the map. Further, according to various embodiments of the present invention, user settings for the map application being currently executed may be defined. If the user starts the map application, default user settings may be loaded.

In operation 2604, a map component extracting unit (e.g., the map component extracting unit 521) may receive map components (e.g., map vector data) from an external electronic device or a storage unit (e.g., the storage unit 540) as set forth above. The received map vector data may include road-related information, land-related information, or building-related information.

In operation 2606, a frame (e.g., a pattern frame) may be defined based on the map vector data. For example, the electronic map generating unit 523 may configure the pattern frame from the received map vector data. For example, the pattern frame may be reconfigured in the form of a pattern through the process of simplifying and linearizeing roads and sections. Further, colors, shadows, or patterns may various be arranged on similar types of patterns, enabling them to be distinguished from each other.

In operation 2608, POI data for pattern frames may be defined based on map vector data. For example, POI data to be displayed on each pattern frame on the electronic map may be defined. According to various embodiments of the present invention, since the pattern frames aims to raise the legibility for a particular place, others than the major POI may be omitted.

In operation 2610, the POI data may be linked or mapped to at least one frame included in each pattern frame through content containing a particular function. For example, if a particular POI is selected from a particular pattern frame, a particular application linked or mapped thereto may be executed. For example, if the POI is selected, a particular webpage may be displayed on a webbrowser, or an Internet search may be done through a search keyword.

In operation 2612, POI data may be combined with the pattern frame. For example, when each pattern frame is displayed, the POI may be displayed on at least part of the pattern frame, and in operation 2614, the POI combined with each pattern frame may be displayed. If the user selects the displayed POI, a designated operation may be performed.

If a preset pattern frame or POI is selected in operation 2616, the operation designated for the POI or selected pattern frame may be performed in operation 2618.

FIG. 27 illustrates one of various embodiments that represent examples of pattern frames. The left-hand part of FIG. 27 illustrates a normal POI list. The normal POI list may include place names in text and map information in images for the corresponding place names. Due to the small screen for the normal POI list and many maps, it is inconvenient to see map information about each item in the list. For example, in the case of wearable devices with a small display, e.g., watch-type wearable devices, the inconvenience of viewing the map information worsens.

Thus, according to various embodiments of the present invention, there is a need for modifying the map into a simplified pattern using the pattern frame. The right-hand part of FIG. 27 illustrates a simplified POI list. The simplified POI list includes place names in text and pattern frames. To generate the pattern frames, road information may be extracted from the raw map vector data, and only roads with a predetermined area or more are left while the other roads are removed.

Further, roads curved to a predetermined degree or more may be transformed into curves close to straight lines while keeping them in shape as possible. Further, the other POIs than the text-marked POIs may be left out. According to various embodiments of the present invention, only the text-marked POIs and modified roads may be displayed on the pattern frame, and a color arrangement may be used to distinguish between sections.

The left-hand part of FIG. 28 illustrates a normal fit type, and the right-hand part of FIG. 28 illustrates a simplified fit type reconfigured according to various embodiments of the present invention. According to various embodiments of the present invention, the figure of the simplified fit type includes pattern frames along with place names in text.

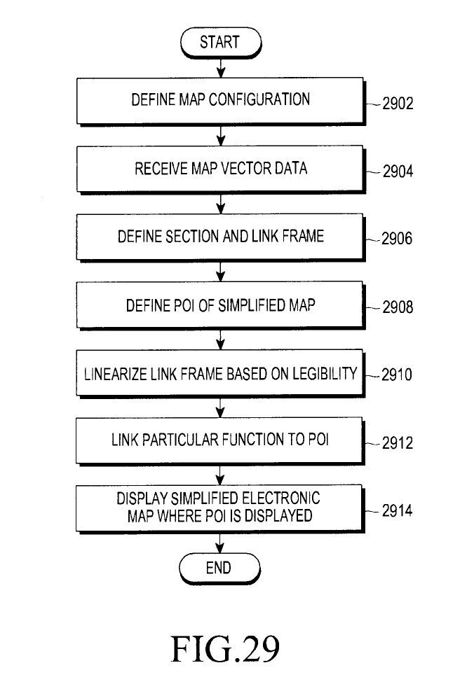

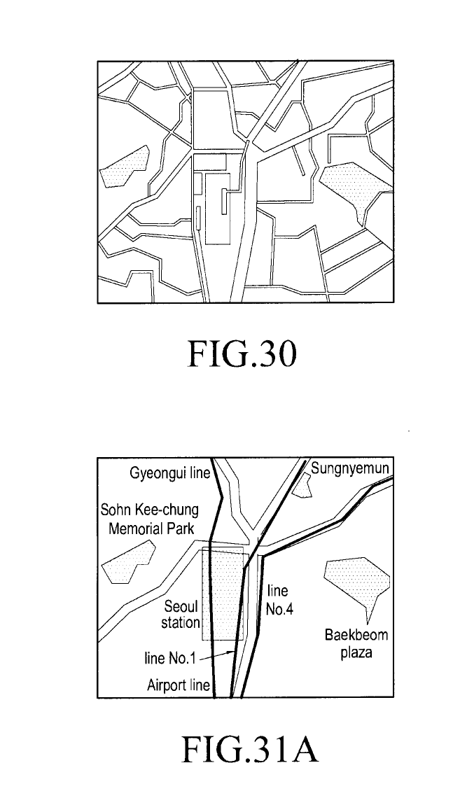

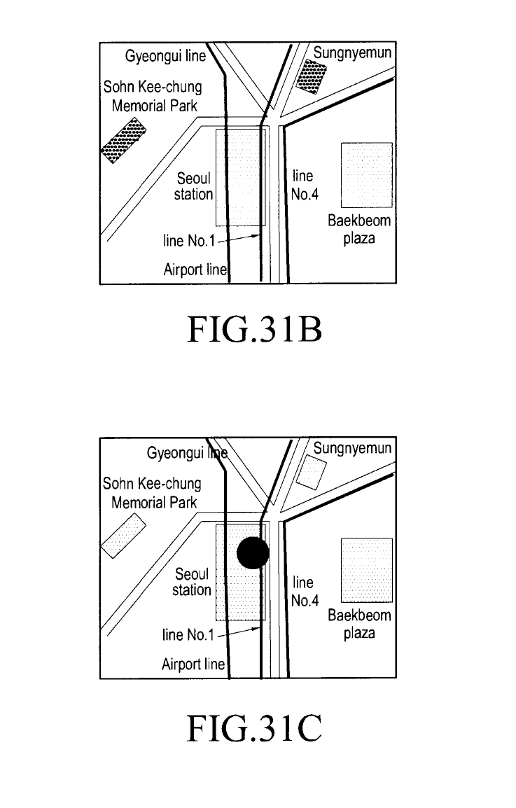

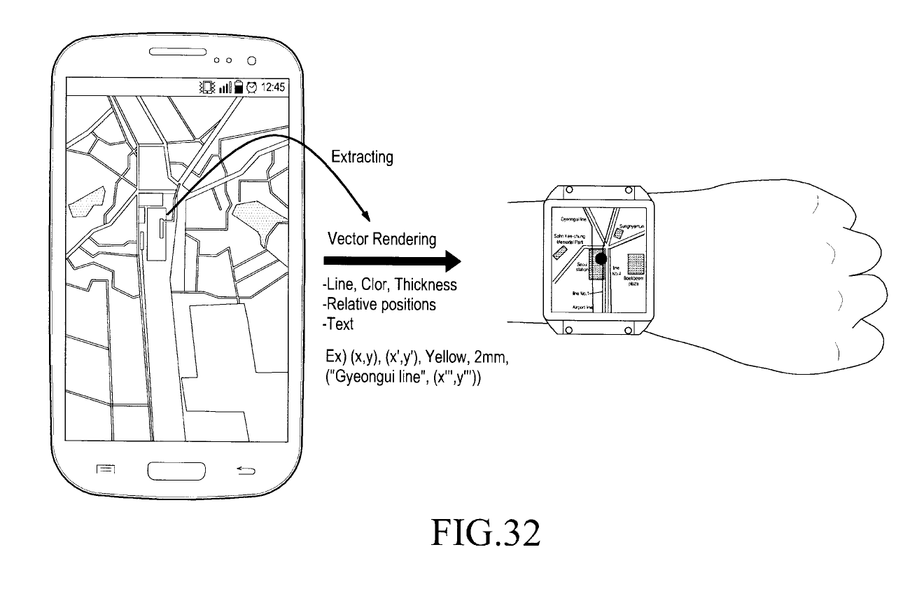

FIG. 29 is a flowchart illustrating a procedure for displaying an electronic map with simplified map vector data according to various embodiments of the present invention. FIG. 30 is a view illustrating an example of displaying an electronic map before performing a simplification process according to various embodiments of the present invention. FIGS. 31a, 31b, and 31c are views illustrating an example of displaying an electronic map that has undergone a simplification process according to various embodiments of the present invention. FIG. 32 is a view illustrating an example of transmitting simplified map vector data according to various embodiments of the present invention.

According to various embodiments of the present invention, the simplified map vector data function may simplify the shape of map components themselves and convert the simplified information into a vector form, enabling easier storage. Further, according to an embodiment of the present invention, the map vector data function enables a map to be configured even with no map data per zoom level when magnifying/shrinking the electronic map. Further, since it has vector-type data, although the zoom level is varied, no loss occurs.

According to various embodiments of the present invention, even a device, e.g., a wearable device, that does not have all maps for an area to be displayed, may draw a map only with vector data received from a smartphone, enabling rendering of an electronic map even without a separate map engine. This reduces the amount of data consumed when downloading, loading, and then transmitting electronic map data, curtaining current consumption as required.

Referring to FIG. 29, a map configuration may be defined in operation 2902. For example, according to various embodiments of the present invention, configuration information on the map may be defined, and the defined configuration may include configurations, such as coordinates, zoom level, or radius of the area selected on the map. Further, according to various embodiments of the present invention, user settings for the map application being currently executed may be defined. If the user starts the map application, default user settings may be loaded.

In operation 2904, a map component extracting unit (e.g., the map component extracting unit 521) may receive map components (e.g., map vector data) from an external electronic device or a storage unit (e.g., the storage unit 540) as set forth above. The received map vector data may include building-related information, building floor information, and information regarding shops in the building.

In operation 2906, a frame (e.g., a link or section frame) may be defined based on the map vector data. For example, section frames for places (areas) supposed to be displayed on the electronic map may be distinguished. Further, link frame information to connect the sections may be screened. For example, the section or link frame may generate a frame appropriate for display on the watch-type wearable device.

In operation 2908, POI data of a simplified map may be defined. For example, POI data to be appropriate for display on the simplified electronic map may be defined. According to various embodiments of the present invention, the POI may be categorized (into, e.g., restaurant, health, or point of interest) according to criteria preset by the user. For example, the simplified map aims to raise legibility for a particular place that the user has interest in or the display of which is useful. It is possible to display major POIs alone with the other POIs omitted.

In operation 2910, the link frame may be linearizeed based on visibility. For example, according to various embodiments of the present invention, the screened link frame may be simplified in the range of not missing the semantics. Besides the link frame, it is also possible to simplify the section frame. For example, in the case of polygons, it may be modified into a shape convenient for the user to grasp, e.g., a simple rectangle or circle.

In operation 2910, the POI data may be linked or mapped to each section frame or link frame through content containing a particular function. For example, if a particular area or section in a particular section frame or link frame is chosen and a particular POI is selected, a particular application linked or mapped thereto may be executed. For example, if the particular area or section is selected, a particular webpage may be displayed on a webbrowser, or an Internet search may be done through a search keyword.

In operation 2912, POI data may be combined with the section frame or link frame. For example, the POI may be displayed in each area or section corresponding to each section frame or link frame, and in operation 2914, the POI combined with each section frame or link frame may be displayed. If the user selects the displayed POI, a designated operation may be performed.

FIG. 30 shows the type of a map typically displayed on a smartphone, representing all map components included in the area (section) supposed to be displayed on the display. Such way may not comply with the user's purposes of reading the map and come to the conclusion that individual pieces of information have been represented with the same degree of importance although the degrees of importance may have weights. In this case, the POI that the user is supposed to be interested in and aware of, the directivity for movement, or route may be hard to immediately figure out.

FIGS. 31a, 31b, and 31c illustrate a process for converting into a simplified map according to various embodiments of the present invention. Referring to FIG. 31a, map components displayable in an area (section) are screened. It is assumed to screen roads, buildings, major POIs, and user preference reflected traffic information (buses, subway routes, etc.) basically configured to meet screening references, i.e., to fit map configurations from a sematics point of view among numorous map components.

FIG. 31a illustrates a first simplified vector map constituted of the screened pieces of information. As compared with the map of FIG. 30, it can be shown that there are no significant differences in map area (section). Here, as shown in FIG. 31b, it is subjected to the process of linearizeing links (roads or rails) connecting buildings and POIs.

Lastly, as shown in FIG. 31c, if the current location of the user is represented as “here you are,” a simplified map that is simple and enough to meet the purposes of map as compared with the original map shown in FIG. 30 may be obtained.

FIG. 32 illustrates a method for sharing map information through simplified map vector on a smailphone and a wearable device (e.g., a watch-type wearable device).

Generally, smartphones have superior hardware to watch-type wearable devices. For example, smartphones have various advantages, such as relatively power computing performance, large display size, and large-capacity battery. Smartphones also come with various sensors (GPS, acceleration, etc.) and relevant wireless hardware components to enhance the accuracy of map. Thus, the simplified map may be utilized when transmitting the map information to the wearable device (e.g., a watch-type wearable device), as well as when representing the smartphone's own map, as shown in FIG. 32.

For example, since the map simplified and reconfigured on the smailphone is represented in the form of vector data, the amount of data supposed to be sent to the wearable device may be curtailed. Further, the wearable device which has insufficient storage and computing power is not required to have a separate map rendering engine to display map.

According to various embodiments of the present invention, the smailphone may display the map in its normal form and internally generate vector data of a corresponding area (section) in the simplified map. Since linearization has been done on the smailphone, only such data as the coordinates and color of display of each sectioned location, the length of display on the screen, text to be displayed, and position of display, may be transmitted to the watch-type wearable device.

The watch-type wearable device may receive the vector data from the smailphone and simply display on the screen. Thereafter, according to the context requiring update on the watch-type wearable device (e.g., a user input-move location on map, search or user's relocation), the smartphone may transmit the vector data to the watch-type wearable device, therebly enabling updating data.

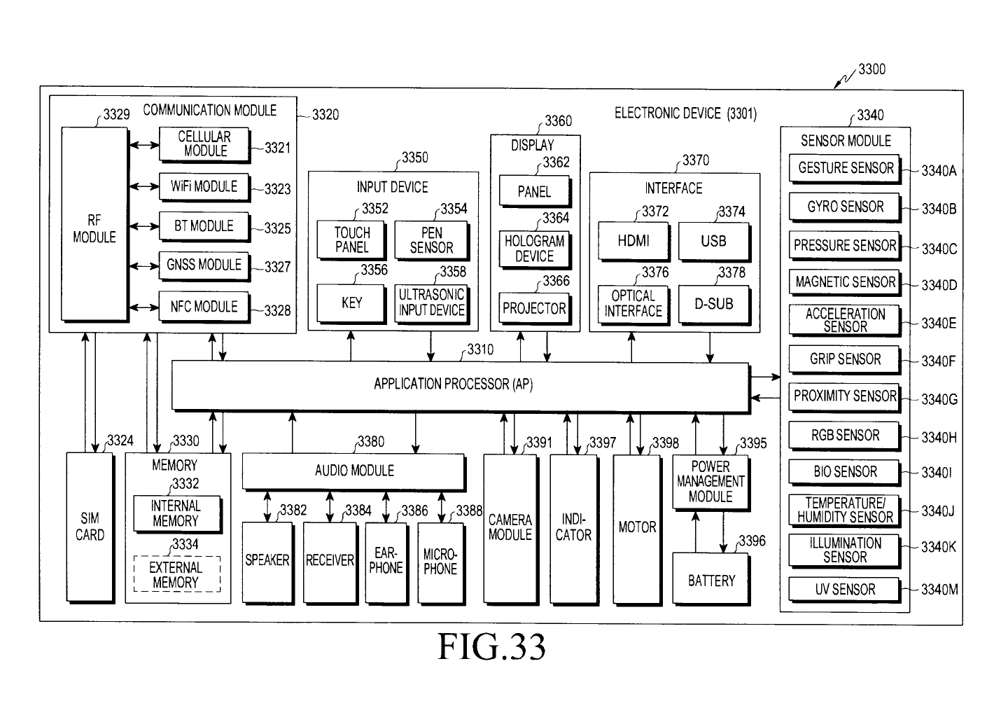

FIG. 33 is a block diagram 3300 illustrating an electronic device 3301 according to an embodiment of the present invention. The electronic device 3301 may include the whole or part of, e.g., the electronic device shown in FIG. 5. The electronic device 3301 may include one or more application processors (APs) 3310, a communication module 3320, an SIM (subscriber identification module) card 3324, a memory 3330, a sensor module 3340, an input device 3350, a display 3360, an interface 3370, an audio module 3380, a camera module 3391, a power management module 3395, a battery 3396, an indicator 3397, and a motor 3398.

The AP 3310 may control multiple hardware and software components connected to the AP 3310 by running, e.g., an operating system or application programs, and the AP 932 may process and compute various data. The AP 3310 may be implemented in, e.g., a system-on-chip (SoC). According to an embodiment of the present invention, the AP 3310 may further include a graphic processing unit (GPU) and/or an image signal processor. The AP 3310 may include at least some (e.g., the cellular module 3321) of the components shown in FIG. 33. The AP 3310 may load a command or data received from at least one of other components (e.g., a non-volatile memory) on a volatile memory, process the command or data, and store various data in the non-volatile memory.

The communication module 3320 may include, e.g., a cellular module 3321, a wireless fidelity (Wi-Fi) module 3323, a bluetooth (BT) module 3325, a GPS module 3327, a NFC module 3328, and a RF module 3329.

The cellular module 3321 may provide voice call, video call, text, or Internet services through a communication network (e.g., a long term evolution (LTE), LTE-advanced (LTE-A), code dividion multiple access (CDMA), wideband CDMA (WCDMA), universal mobile telecommunications system (UMTS), wireless broadcast (WiBro), or global system for mobile communications (GSM) network). According to an embodiment of the present invention, the cellular module 3321 may perform identification or authentication on the electronic device 3301 in the communication network using a subscriber identification module (e.g., the SIM card 3324). According to an embodiment of the present invention, the cellular module 3321 may perform at least some of the functions providable by the AP 3310. According to an embodiment of the present invention, the cellular module 3321 may include a communication processor (CP).

The Wi-Fi module 3323, the BT module 3325, the GPS module 3327, or the NFC module 3328 may include a process for, e.g., processing data communicated through the module. At least some (e.g., two or more) of the cellular module 3321, the Wi-Fi module 3323, the BT module 3325, the GPS module 3327, and the NFC module 3328 may be included in a single integrated circuit (IC) or an IC package.

The RF module 3329 may communicate data, e.g., communication signals (e.g., RF signals). The RF module 3329 may include, e.g., a transceiver, a power amp module (PAM), a frequency filter, a low noise amplifier (LNA), or an antenna. According to an embodiment of the present invention, at least one of the cellular module 3321, the Wi-Fi module 3323, the BT module 3325, the GPS module 3327, or the NFC module 3328 may communicate RF signals through a separate RF module.

The SIM card 3324 may include, e.g., a card including a subscriber identification module and/or an embedded SIM, and may contain unique identification information (e.g., an integrated circuit card identifier (ICCID) or subscriber information (e.g., an international mobile subscriber identity (IMSI)).

The memory 3330 (e.g., the memory 3330) may include, e.g., an internal memory 3332 or an external memory 3334. The internal memory 3332 may include at least one of, e.g., a volatile memory (e.g., a dynamic RAM (DRAM), a static RAM (SRAM), a synchronous dynamic RAM (SDRAM), etc.) or a non-volatile memory (e.g., a one time programmable ROM (OTPROM), a programmable ROM (PROM), an erasable and programmable ROM (EPROM), an electrically erasable and programmable ROM (EEPROM), a mask ROM, a flash ROM, a flash memory (e.g., a NAND flash, or a NOR flash), a hard drive, or solid state drive (SSD).

The external memory 3334 may further include a flash drive, e.g., a compact flash (CF) memory, a secure digital (SD) memory, a micro-SD memory, a min-SD memory, an extreme digital (xD) memory, or a memory stick™. The external memory 3334 may be functionally and/or physically connected with the electronic device 3301 via various interfaces.

For example, the sensor module 3340 may measure a physical quantity or detect a motion state of the electronic device 3301, and the sensor module 240 may convert the measured or detected information into an electrical signal. The sensor module 3340 may include at least one of, e.g., a gesture sensor 3340A, a gyro sensor 3340B, an air pressure sensor 3340C, a magnetic sensor 3340D, an acceleration sensor 3340E, a grip sensor 3340F, a proximity sensor 3340G, a color sensor 3340H such as an red-green-blue (RGB) sensor, a bio sensor 33401, a temperature/humidity sensor 3340J, an illumination sensor 3340K, or an ultra violet (UV) sensor 3340M. Additionally or alternatively, the sensing module 3340 may include, e.g., an e-nose sensor, an electromyography (EMG) sensor, an electroencephalogram (EEG) sensor, an electrocardiogram (ECG) sensor, an infrared (IR) sensor, an iris sensor, or a finger print sensor. The sensor module 3340 may further include a control circuit for controlling at least one or more of the sensors included in the sensing module. According to an embodiment of the present invention, the electronic device 3301 may further include a processor configured to control the sensor module 3340 as part of an AP 3310 or separately from the AP 3310, and the electronic device 931 may control the sensor module 3340 while the AP is in a sleep mode.

The input unit 3350 may include, e.g., a touch panel 3352, a (digital) pen sensor 3354, a key 3356, or an ultrasonic input device 3358. The touch panel 3352 may use at least one of capacitive, resistive, infrared, or ultrasonic methods. The touch panel 3352 may further include a control circuit. The touch panel 3352 may further include a tactile layer and may provide a user with a tactile reaction.

The (digital) pen sensor 3354 may include, e.g., a part of a touch panel or a separate sheet for recognition. The key 3356 may include e.g., a physical button, optical key or key pad. The ultrasonic input device 3358 may use an input tool that generates an ultrasonic signal and enable the electronic device 3301 to identify data by sensing the ultrasonic signal to a microphone (e.g., a microphone 3388).

The display 3360 may include a panel 3362, a hologram device 3364, or a projector 3366. The panel 3362 may be implemented to be flexible, transparent, or wearable. The panel 3362 may also be incorporated with the touch panel 3352 in a module. The hologram device 3364 may make three dimensional (3D) images (holograms) in the air by using light interference. The projector 3366 may display an image by projecting light onto a screen. The screen may be, for example, located inside or outside of the electronic device 3301. In accordance with an embodiment, the display 3360 may further include a control circuit to control the panel 3362, the hologram device 3364, or the projector 3366.

The interface 3370 may include e.g., a high definition multimedia interface (HDMI) 3372, a USB 3374, an optical interface 3376, or a D-subminiature (D-sub) 3378. Additionally or alternatively, the interface 3370 may include a mobile high-definition link (MHL) interface, a secure digital (SD) card/ multimedia card (MMC) interface, or infrared data association (IrDA) standard interface.

The audio module 3380 may converting, e.g., a sound signal into an electrical signal and vice versa. The audio module 3380 may process sound information input or output through e.g., a speaker 3382, a receiver 3384, an earphone 3386, or a microphone 3388.

For example, the camera module 3391 may be a device for capturing still images and videos, and may include, according to an embodiment of the present invention, one or more image sensors (e.g., front and back sensors), a lens, an image signal processor (ISP), or a flash such as an LED or xenon lamp.

The power manager module 3395 may manage power of the electronic device 3301, for example. According to an embodiment of the present invention, the power manager module 3395 may include a power management Integrated circuit (PMIC), a charger IC, or a battery or fuel gauge. The PMIC may have a wired and/or wireless recharging scheme. The wireless charging scheme may include e.g., a magnetic resonance scheme, a magnetic induction scheme, or an electromagnetic wave based scheme, and an additional circuit, such as a coil loop, a resonance circuit, a rectifier, or the like may be added for wireless charging. The battery gauge may measure an amount of remaining power of the battery 3396, a voltage, a current, or a temperature while the battery 2696 is being charged. The battery 3396 may include, e.g., a rechargeable battery or a solar battery.

The indicator 3397 may indicate a particular state of the electronic device 3301 or a part of the electronic device (e.g., the AP 3310), including e.g., a booting state, a message state, or recharging state. The motor 3398 may convert an electric signal to a mechanical vibration and may generate a vibrational or haptic effect. Although not shown, a processing unit for supporting mobile TV, such as a GPU may be included in the electronic device 3301. The processing unit for supporting mobile TV may process media data conforming to a standard for digital multimedia broadcasting (DMB), digital video broadcasting (DVB), or mediaFlo™.

Each of the aforementioned components of the electronic device may include one or more parts, and a name of the part may vary with a type of the electronic device. The electronic device in accordance with various embodiments of the present invention may include at lest one of the aforementioned components, omit some of them, or include other additional component(s). Some of the components may be combined into an entity, but the entity may perform the same functions as the components may do.

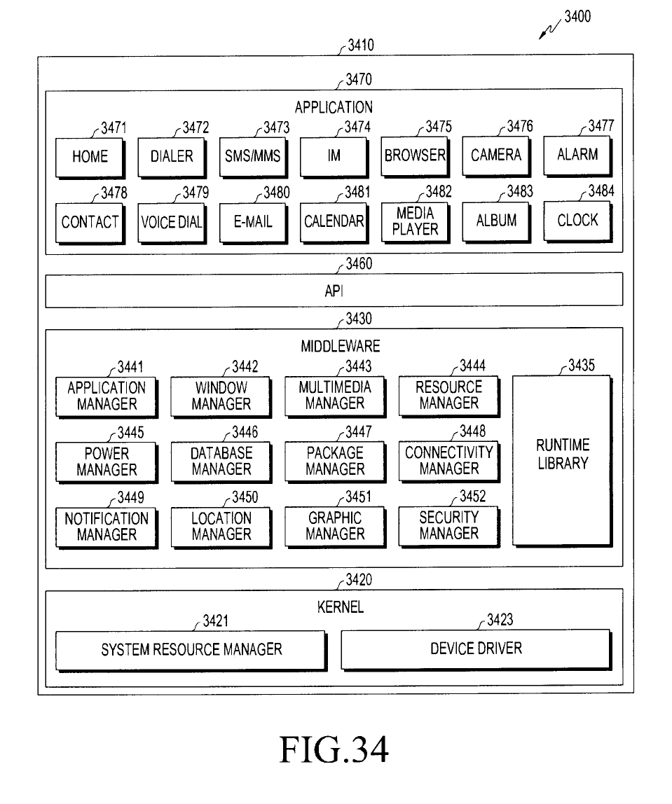

FIG. 34 is a block diagram 3400 illustrating a program module 3410 according to an embodiment of the present invention. According to an embodiment of the present invention, the program module 3410 may include an operating system (OS) controlling resources related to the electronic device and/or various applications (e.g., the application program) driven on the operating system. The operating system may include, e.g., Android, iOS, Windows, Symbian, Tizen, or Bada.

The program 3410 may include, e.g., a kernel 3420, middleware 3430, an application programming interface (API) 3460, and/or an application 3470. At least a part of the program module 3410 may be preloaded on the electronic device or may be downloaded from a server.

The kernel 3420 may include, e.g., a system resource manager 3421 or a device driver 3423. The system resource manager 3421 may perform control, allocation, or recovery of system resources. According to an embodiment of the present invention, the system resource manager 3421 may include a process managing unit, a memory managing unit, or a file system managing unit. The device driver 3423 may include, e.g., a display driver, a camera driver, a Bluetooth driver, a shared memory driver, a USB driver, a keypad driver, a Wi-Fi driver, an audio driver, or an inter-process communication (IPC) driver.

The middleware 3430 may provide various functions to the application 3470 through the API 3460 so that the application 3470 may efficiently use limited system resources in the electronic device or provide functions jointly required by applications 3470. According to an embodiment of the present invention, the middleware 2030 (e.g., the middleware 3430) may include at least one of a runtime library 3435, an application manager 3441, a window manager 3442, a multimedia manager 3443, a resource manager 3444, a power manager 3445, a database manager 3446, a package manager 3447, a connectivity manager 3448, a notification manager 3449, a location manager 3450, a graphic manager 3451, or a security manager 3452.

The runtime library 3435 may include a library module used by a compiler in order to add a new function through a programming language while, e.g., the application 3470 is being executed. The runtime library 3435 may perform input/output management, memory management, or operation on arithmetic functions.

The application manager 3441 may manage the life cycle of at least one application of, e.g., the applications 3470. The window manager 3442 may manage GUI resources used on the screen. The multimedia manager 3443 may grasp formats necessary to play various media files and use a codec appropriate for a format to perform encoding or decoding on media files. The resource manager 3444 may manage resources, such as source code of at least one of the applications 3470, memory or storage space.

The power manager 3445 may operate together with, e.g., a basic input/output system (BIOS) to manage battery or power and provide power information necessary for operating the electronic device. The database manager 3446 may generate, search, or vary a database to be used in at least one of the applications 3470. The package manager 3447 may manage installation or update of an application that is distributed in the form of a package file.

The connectivity manager 3448 may manage wireless connectivity, such as, e.g., Wi-Fi or Bluetooth. The notification manager 3449 may display or notify an event, such as a coming message, appointment, or proximity notification, of the user without interfering with the user. The location manager 3450 may manage locational information on the electronic device. The graphic manager 3451 may manage graphic effects to be offered to the user and their related user interface. The security manager 3452 may provide various security functions necessary for system security or user authentication. According to an embodiment of the present invention, when the electronic device (e.g., the electronic device of FIG. 8) has telephony capability, the middleware 3430 may further include a telephony manager for managing voice call or video call functions of the electronic device.

The middleware 3430 may include a middleware module forming a combination of various functions of the above-described components. The middleware 3430 may provided a specified module per type of the operating system in order to provide a differentiated function. Further, the middleware 3430 may dynamically omit some existing components or add new components.

The API 3460 may be a set of, e.g., API programming functions and may have different configurations depending on operating systems. For example, in the case of Android or iOS, one API set may be provided per platform, and in the case of Tizen, two or more API sets may be offered per platform.

The application 3470 may include one or more applications that may provide functions such as, e.g., a home 3471, a dialer 3472, an SMS/MMS 3473, an instant message (IM) 3474, a browser 3475, a camera 3476, an alarm 3477, a contact 3478, a voice dial 3479, an email 3480, a calendar 3481, a media player 3482, an album 3483, or a clock 3484, a heath-care (e.g., measuring the degree of workout or bloodsugar), or provision of environmental information (e.g., provision of air pressure, moisture, or temperature information).

According to an embodiment of the present invention, the application 3470 may include an application (hereinafter, “information exchanging application” for convenience) supporting information exchange between the electronic device (e.g., the electronic device of FIGS. 1 to 5) and an external electronic device. Examples of the information exchange application may include, but is not limited to, a notification relay application for transferring specific information to the external electronic device, or a device management application for managing the external electronic device.

For example, the notification relay application may include a function for relaying notification information generated from other applications of the electronic device (e.g., the SMS/MMS application, email application, health-care application, or environmental information application) to the external electronic device. Further, the notification relay application may receive notification information from, e.g., the external electronic device and may provide the received notification information to the user. The device management application may perform at least one function of the external electronic device communicating with the electronic device (for example, turning on/off the external electronic device (or some components of the external electronic device) or control of brightness (or resolution) of the display), and the device management application may manage (e.g., install, delete, or update) an application operating in the external electronic device or a service (e.g., call service or message service) provided from the external electronic device.

According to an embodiment of the present invention, the application 3470 may include an application (e.g., a health-care application) designated depending on the attribute (e.g., as an attribute of the electronic device, the type of electronic device is a mobile medical device) of the external electronic device. According to an embodiment of the present invention, the application 3470 may include an application received from the external electronic device. According to an embodiment of the present invention, the application 3470 may include a preloaded application or a third party application downloadable from a server. The names of the components of the program module 3410 according to the shown embodiment may be varied depending on the type of operating system.

According to an embodiment of the present invention, at least a part of the program module 3410 may be implemented in software, firmware, hardware, or in a combination of two or more thereof. At least a part of the programming module 3410 may be implemented (e.g., executed) by e.g., a processor (e.g., the AP 3310). At least a part of the program module 3410 may include e.g., a module, program, routine, set of instructions, process, or the like for performing one or more functions.

The term ‘module’ or ‘functional unit’ may refer to a unit including one of hardware, software, and firmware, or a combination thereof The term ‘module’ or ‘functional unit’ may be interchangeably used with a unit, logic, logical block, component, or circuit. The term ‘module’ or ‘functional unit’ may be a minimum unit or part of an integrated component. The ‘module’ may be a minimum unit or part of performing one or more functions. The ‘module’ or ‘functional unit’ may be implemented mechanically or electronically. For example, the ‘module’ or ‘functional unit’ may include at least one of Application Specific Integrated Circuit (ASIC) chips, Field Programmable Gate Arrays (FPGAs), or Programmable Logic Arrays (PLAs) that perform some operations, which have already been known or will be developed in the future.

According to an embodiment of the present invention, at least a part of the device (e.g., modules or their functions) or method (e.g., operations) may be implemented as instructions stored in a computer-readable storage medium e.g., in the form of a program module. The instructions, when executed by a processor (e.g., the controller 520), may enable the processor to carry out a corresponding function. The computer-readable storage medium may be e.g., the storage unit 540.

The computer-readable storage medium may include a hardware device, such as hard discs, floppy discs, and magnetic tapes (e.g., a magnetic tape), optical media such as compact disc ROMs (CD-ROMs) and digital versatile discs (DVDs), magneto-optical media such as floptical disks, ROMs, RAMs, flash memories, and/or the like. Examples of the program commands may include not only machine language codes but also high-level language codes which are executable by various computing means using an interpreter. The aforementioned hardware devices may be configured to operate as one or more software modules to carry out exemplary embodiments of the present invention, and vice versa.

Modules or programming modules in accordance with various embodiments of the present invention may include at least one or more of the aforementioned components, omit some of them, or further include other additional components. Operations performed by modules, programming modules or other components in accordance with various embodiments of the present invention may be carried out sequentially, simultaneously, repeatedly, or heuristically. Furthermore, some of the operations may be performed in a different order, or omitted, or include other additional operation(s).

According to any one of various embodiments of the present invention, there may be provided a storage medium storing commands that are configured to be executed by at least one processor to enable the at least one processor to perform at least one operation that may comprise the operations of selecting at least one of map components constituting the electronic map, reconfiguring the at least one selected map component according to a preset condition, and generating the electronic map using the reconfigured map component.

The embodiments herein are provided merely for better understanding of the present invention, and the present invention should not be limited thereto or thereby. It should be appreciated by one of ordinary skill in the art that various changes in form or detail may be made to the embodiments without departing from the scope of the present invention defined by the following claims.

1. An electronic device, comprising:
a storage unit storing map components;
a controller performing control to reconfigure at least one of the map components stored in the storage unit according to a preset condition and to generate an electronic map using the reconfigured map components; and
a display unit displaying the generated electronic map on a screen.

2. The electronic device of claim 1, wherein the storage unit further stores map component configuration information, wherein the controller reconfigures the map components based on the map component configuration information.

3. The electronic device of claim 1, wherein the map components include at least one of a text, a point of interest (POI), a road, and a land.

4. The electronic device of claim 1, wherein the controller simplifies and reconfigures the at least one selected map component.

5. The electronic device of claim 1, wherein the controller reconfigures the at least one selected map component by creating a block for the at least one map component of the electronic map.

6. The electronic device of claim 1, wherein the controller adjusts a direction of display of a text among the at least one selected map component based on an orientation of the screen of the electronic device.

7. The electronic device of claim 1, wherein the controller varies or resizes a font of a text among the at least one selected map component.

8. The electronic device of claim 1, wherein the controller adjusts the number of POIs to be displayed depending on priority or importance of the POIs among the at least one selected map component.

9. The electronic device of claim 1, wherein, for a road among the at least one selected map component, the controller reconfigures the road by linearizing the road that is curved, deletes the road to prevent roads below a preset reference from being displayed, reconfigures the road to allow roads above the preset reference to be highlighted, or adjusts a thickness of the road according to a setting.

10. The electronic device of claim 1, wherein the controller forms at least one frame by simplifying topography among the at least one selected map component and maps at least one piece of POI information to each frame formed.

11. A method for displaying an electronic map on an electronic device, the method comprising the operations of:
selecting at least one of map components constituting the electronic map;
reconfiguring the at least one selected map component according to a preset condition; and
generating the electronic map using the reconfigured map component.

12. The method of claim 11, wherein the reconfiguring operation is reconfiguring the map component based on preset map component configuration information.

13. The method of claim 11, wherein the map components include at least one of a text, a point of interest (POI), a road, and a land.

14. The method of claim 11, wherein the reconfiguring operation is simplifying and reconfiguring the at least one selected map component.

15. The method of claim 11, wherein the reconfiguring operation is reconfiguring the at least one selected map component by creating a block for the at least one map component of the electronic map.

16. The method of claim 11, wherein the reconfiguring operation is adjusting a direction of display of a text among the at least one selected map component based on an orientation of the screen of the electronic device.

17. The method of claim 11, wherein the reconfiguring operation is varying or resizing a font of a text among the at least one selected map component.

18. The method of claim 11, wherein the reconfiguring operation is adjusting the number of POIs to be displayed depending on priority or importance of the POIs among the at least one selected map component.

19. The method of claim 11, wherein, for a road among the at least one selected map component, the reconfiguring operation is reconfiguring the road by linearizing the road that is curved, deleting the road to prevent roads below a preset reference from being displayed, reconfiguring the road to allow roads above the preset reference to be highlighted, or adjusting a thickness of the road according to a setting.

20. The method of claim 11, wherein the reconfiguring operation is forming at least one frame by simplifying topography among the at least one selected map component and mapping at least one piece of POI information to each frame formed.
